(19) United States
(12) Patent Application Publication
(10) Pub. No.: US 2026/0082208 A1
(43) Pub. Date: Mar. 19, 2026

(54) METHOD AND APPARATUS FOR CONFIGURING SHARED CELL IN COMMUNICATION SYSTEM

(71) Applicant: SOLiD, INC., Seongnam-si (KR)

(72) Inventor: Hoony HONG, Seoul (KR)

(73) Assignee: SOLiD, INC., Seongnam-si (KR)

(21) Appl. No.: 19/393,824

(22) Filed: Nov. 19, 2025

Related U.S. Application Data
(62) Division of application No. 18/458,677, filed on Aug. 30, 2023.

(30) Foreign Application Priority Data
Aug. 30, 2022 (KR) 10-2022-0109430
Sep. 7, 2022 (KR) 10-2022-0113748
Aug. 30, 2023 (KR) 10-2023-0114508

(51) Int. Cl. H04W 8/22; H04L 27/26; H04W 68/02; H04W 72/1268; H04W 74/0833

(52) U.S. Cl. CPC H04W 8/22; H04L 27/26025; H04W 68/02; H04W 72/1268; H04W 74/0833

(57) ABSTRACT

A method performed by a middle node in a communication system includes: receiving a request message for capability information from a controller; transmitting capability information of the middle node as a response to the request message; and receiving configuration information for an extended antenna carrier (eAxC)_identifier (ID) group supporting Section Extension 10 based on the capability information of the middle node from the controller.

### CROSS-REFERENCE TO RELATED APPLICATIONS

This application is a divisional of U.S. application Ser. No. 18/458,677 filed on Aug. 30, 2023, which claims the benefits of Korean Patent Applications No. 10-2022-0109430, filed on Aug. 30, 2022, No. 10-2022-0113748, filed on Sep. 7, 2022 and No. 10-2023-0114508, filed on Aug. 30, 2023, in the Korean Intellectual Property Office, the disclosures of which are incorporated herein in their entireties by reference.

### BACKGROUND

### 1. Field

The present disclosure relates to a method and a device for configuring a shared cell in a communication system, and more particularly, to a device and method for configuring a shared cell in a network infrastructure.

### 2. Description of the Related Art

As wireless communication systems develop and evolve into 4th generation communication systems and 5g generation communication systems, various functions and specifications are required. In order to satisfy these functions and specifications, various methods have been introduced, and one of them is a method of implementing a network infrastructure by functionally splitting it. As a representative configuration of the functional split method, a base station may be represented as a centralized unit (CU), distributed unit (DU), and radio unit (RU) depending on its function, and the interface of each unit is defined by organizations such as 3GPP and O-RAN alliance.

### SUMMARY

Provided are methods of configuring a shared cell to efficiently utilize communication in a fronthaul.

Provided are methods of configuring a shared cell to reduce resource waste and increase communication quality when performing communication in O-RAN.

According to an aspect of an embodiment, A method performed by a middle node in a communication system, the method comprising receiving a request message for capability information from a controller; transmitting capability information of the middle node in response to the request message; and receiving configuration information for an extended antenna carrier (eAxC)_identifier (ID) group supporting Section Extension 10 based on the capability information of the middle node from the controller.

In addition, wherein the capability information of the middle node comprises information about a maximum number of eAxC_ID groups by the middle node being able to process and information about a maximum number of eAxC_IDs that can be included in one eAxC_ID group.

In addition, wherein the configuration information for the eAxC_ID group comprises information about a representative eAxC_ID of the eAxC_ID group and information about at least one member eAxC_ID included in the eAxC_ID group.

In addition, the method further comprises receiving a control plane message from an O-RAN distributed unit (O-DU); and extending a control plane message of a representative eAxC_ID to a control plane message of at least one member eAxC_ID corresponding to the representative eAxC_ID based on the configuration information for the eAxC_ID group

According to another aspect of an embodiment, a middle node in a communication system, the middle node comprising a transceiver; a memory; and at least one processor electrically connected to the transceiver and the memory, wherein the at least one processor is configured to receive a request message for capability information from a controller; transmit capability information of the middle node as a response to the request message; and receive configuration information for an extended antenna carrier (eAxC)_identifier (ID) group supporting Section Extension 10 based on the capability information of the middle node from the controller.

According to other aspect of an embodiment, a method performed by a middle node in a communication system, the method comprising: identifying a section type 3 control plane message indicating an uplink packet; determining user plane symbol reference timing based on the section type 3 control plane message; determining combining timing based on the determined user plane symbol reference timing; and paging and combining a stored uplink packet based on the determined combining timing.

In addition, wherein the determining of user plane symbol reference timing based on the section type 3 control plane message comprises identifying at least one of timing parameter, symbolid, timeoffset, cplength, framestructure (subcarrier spacing (SCS)), and numsymbol information included in the control plane message; and determining user plane symbol reference timing based on the identified information and a subframe boundary or slot boundary.

In addition, wherein the paging and combining of a stored uplink packet based on the determined combining timing comprises paging data corresponding to the determined combining timing based on symbolid, extended antenna carrier (eAxC)_ID, and transport flow; and, when there are pieces of data with the same symbolid, eAxC_ID, and transport flow and different user plane symbol reference timings, paging data corresponding to the determined combining timing based on filterIndex, sectionId, subframeId, or slotId included in the uplink packet, wherein the transport flow is determined by a combination of a destination and source of a medium access control (MAC) address or an Internet protocol (IP) address.

In addition, wherein the paging of data corresponding to the determined combining timing based on the filterIndex included in the uplink packet comprises identifying, when a value of the filterIndex is 1 to 7, that a corresponding message is a physical random access channel (PRACH) message and paging data; and identifying, when a value of the filterIndex is 8, that a corresponding message is a narrowband physical uplink shared channel (NPUSCH) message and paging data.

In addition, wherein the paging of data corresponding to the determined combining timing based on the sectionId included in the uplink packet comprises referring to sectionId in a control plane message indicating the uplink packet, identifying a user plane message including the sectionId and paging data.

According to other aspect of an embodiment, a middle node in a communication system, the middle node comprising a transceiver; a memory; and at least one processor electrically connected to the transceiver and the memory, wherein the at least one processor is configured to: identify a section type 3 control plane message indicating an uplink packet; determine user plane symbol reference timing based on the section type 3 control plane message; determine combining timing based on the determined user plane symbol reference timing; and page and combine a stored uplink packet based on the determined combining timing.

According to an embodiment, a middle node in a shared cell may identify section extension 10 and perform a combining operation accordingly, thereby saving resources and reducing delay.

In addition, according to the embodiment, resources may be utilized efficiently by having a middle node determine combining timing according to a message type.

Effects according to the inventive concept are not limited to the effects described above, and other effects not described herein may be clearly understood by one of ordinary skill in the art from the following description.

### BRIEF DESCRIPTION OF THE DRAWINGS

Embodiments of the disclosure will be more clearly understood from the following detailed description taken in conjunction with the accompanying drawings in which:

FIG. 1A is a view of a wireless communication system according to various embodiments;

FIG. 1B is a view illustrating an example of a fronthaul structure according to functional split of a base station, according to various embodiments;

FIG. 2 is a view of an O-RAN network system according to an embodiment;

FIG. 3 is a view of a structure of an O-RAN wireless communication system according to an embodiment;

FIG. 4 is a view of a structure of an Ethernet message according to an embodiment;

FIGS. 5A and 5B are views illustrating an example of a C-plane message according to an embodiment;

FIG. 6A is a view of a structure of an O-RAN base station including a middle node according to an embodiment;

FIG. 6B is a view illustrating a situation in which uplink data transmitted from multiple O-DUs included in multiple cells are combined, according to an embodiment;

FIG. 7 is a view illustrating a C-plane using section extension 10 according to an embodiment;

FIG. 8 is a view illustrating a method in which a middle node creates a trigger and performs combining, according to an embodiment;

FIG. 9 is a view illustrating a method of determining combining timing for a plurality of symbol reference timings, according to an embodiment;

FIG. 10A is a view illustrating a process for applying Section extension 10 in a middle node, according to an embodiment;

FIGS. 10B and 10C are views of a structure of a YANG model according to an embodiment;

FIG. 11 is a view of a structure of an eAxC_ID group according to an embodiment;

FIG. 12A is a flowchart illustrating a method by which a middle node combines uplink packets, according to an embodiment;

FIG. 12B is a view illustrating a method of determining symbol timing of a PRACH message, according to an embodiment;

FIG. 12C is a table illustrating filterIndex according to an embodiment;

FIG. 13 is a view of a configuration of a controller according to an embodiment;

FIG. 14 is a view of a configuration of a middle node according to an embodiment;

FIG. 15 is a view of a configuration of an O-DU according to an embodiment; and

FIG. 16 is a view of a configuration of an O-RU according to an embodiment.

### DETAILED DESCRIPTION

Hereinafter, embodiments will be described in detail with the accompanying drawings.

In the description of the embodiments, certain detailed explanations of a related function or configuration are omitted when it is deemed that they may unnecessarily obscure the essence of the disclosure. In addition, the terms described below are defined in consideration of the functions in the disclosure, and may vary depending on the intention or custom of a user or an operator. Therefore, the definition needs to be made based on content throughout this specification.

For the same reason, some components may be exaggerated, omitted, or schematically shown in the accompanying drawings. In addition, the size of each component does not entirely reflect its actual size. In each drawing, identical or corresponding components are given the same reference numerals.

The advantages and features of the disclosure and a method of achieving them will become clear by referring to the embodiments described in detail below along with the accompanying drawings. However, the disclosure is not limited to the embodiments disclosed below, but may be implemented in various different forms. The embodiments are provided to ensure that the description of the disclosure is complete and to fully inform one of ordinary skill in the art of the scope of the disclosure, and the claimed scope of the disclosure is only defined by the scope of the claims.

At this time, it will be understood that each block of processing flow charts and combinations of the processing flow charts may be performed by computer program instructions. Because these computer program instructions may be mounted on a processor of a general-purpose computer, special-purpose computer, or other programmable data processing equipment, the instructions performed through the processor of the computer or other programmable data processing device creates a unit to perform functions described in flow chart block(s). These computer program instructions may also be stored in computer-usable or computer-readable memory that can be directed to a computer or other programmable data processing equipment to implement the functions in a particular manner. Accordingly, the instructions stored in the computer-usable or computer-readable memory may also produce manufactured items containing an instruction unit that performs the functions described in the flow chart block(s). Because the computer program instructions can be mounted on a computer or other programmable data processing equipment, instructions that execute a computer or other programmable data processing equipment by performing a series of operations on a computer or other programmable data processing equipment to generate a computer-executable process may also provide operations for executing the functions described in the flow chart block(s).

In addition, each block may represent a module, segment, or portion of code containing one or more executable instructions for executing specified logical function(s). In addition, in some Alternative implementations, it is possible for functions mentioned in the blocks to occur out of order. For example, two blocks shown in succession may be performed substantially simultaneously, or the blocks may sometimes be performed in reverse order depending on their corresponding functions.

The term “unit or part” used in the disclosure refers to software or hardware components such as a field-programmable gate array (FPGA) or an application specific integrated circuit (ASIC), and the “unit or part” may be configured to perform specific roles. However, the “unit or part” is not limited to software or hardware. The “unit or part” may be configured to be stored in an addressable storing medium or to execute one or more processors. Accordingly, the “unit or part” may include, for example, software components, object-oriented software components, components such as class components and task components, processors, formulas, attributes, procedures, subroutines, segments of program code, drivers, firmware, micro code, circuits, data, database, data structures, tables, arrays and variables. Functions provided in components and “units or parts” may be combined into a smaller number of components and “units or parts”, or may be further divided into additional components and “units or parts.” Furthermore, components and “units or parts” may be implemented to reproduce one or more central processing units within a device or a secure multimedia card. In addition, in an embodiment, “unit or part” may include one or more processors and/or devices.

In various embodiments, the technologies described in the disclosure and systems and devices for implementation thereof may utilize other radio access technologies such as WiFi or WiMax as well as radio access technologies such as code division multiple access (CDMA), time division multiple access (TDMA), frequency division multiple access (FDMA), orthogonal FDMA (OFDMA), single-carrier FDMA (SC-FDMA), LTE, a global system for mobile communications (GSM), 5G NR, and the like to support communication between networks (or systems).

Various other embodiments and features according to the disclosure will be further described later below. It should be apparent that the teachings herein may be implemented in a wide variety of forms and any particular structure, function, or both, disclosed herein are merely exemplary, and not limiting. Based on the teachings herein, one of ordinary skill in the art will appreciate that aspects disclosed herein may be implemented independently of any other aspects, and two or more of these aspects may be combined in various ways. For example, a device or a method may be implemented by using any number of aspects set forth herein. Furthermore, the device or the method may be implemented with structures and functions of one or more of the aspects described herein, or may be implemented by using structures and functions of other aspects. For example, the method may be implemented as part of instructions stored on a non-transitory computer-readable recording medium for execution on a system, a device, an apparatus and/or a processor, or a computer. Furthermore, one aspect may include at least one component of the claim.

Hereinafter, preferred embodiments will be described in detail with reference to the attached drawings. At this time, it should be noted that the same components in the attached drawings are indicated by the same symbols as much as possible. In addition, detailed descriptions of well-known functions and configurations that may obscure the gist of the disclosure will be omitted.

In describing the embodiments in this specification, descriptions of technical content that is well-known in the art and not directly related to the disclosure will be omitted. This is to convey the gist of the disclosure more clearly without obscuring it by omitting unnecessary explanation.

For the same reason, some components are exaggerated, omitted, or schematically shown in the accompanying drawings. In addition, the size of each component does not entirely reflect its actual size. In each drawing, identical or corresponding components are given the same reference numerals.

The advantages and features of the disclosure and a method of achieving them will become clear by referring to the embodiments described in detail below along with the accompanying drawings. However, the disclosure is not limited to the embodiments disclosed below, but may be implemented in various different forms. The embodiments are provided to ensure that the description of the disclosure is complete and to fully inform one of ordinary skill in the art of the scope of the disclosure, and the disclosure is only defined by the scope of the claims. Like reference numerals refer to like elements throughout.

At this time, it will be understood that each block of processing flow charts and combinations of the processing flow charts may be performed by computer program instructions. Because these computer program instructions may be mounted on a processor of a general-purpose computer, special-purpose computer, or other programmable data processing equipment, the instructions performed through the processor of the computer or other programmable data processing device creates a unit to perform functions described in flow chart block(s). These computer program instructions may also be stored in computer-usable or computer-readable memory that can be directed to a computer or other programmable data processing equipment to implement the functions in a particular manner. Accordingly, the instructions stored in the computer-usable or computer-readable memory may also produce manufactured items containing an instruction unit that performs the functions described in the flow chart block(s). Because the computer program instructions can be mounted on a computer or other programmable data processing equipment, instructions that execute a computer or other programmable data processing equipment by performing a series of operations on a computer or other programmable data processing equipment to generate a computer-executable process may also provide operations for executing the functions described in the flow chart block(s).

In addition, each block may represent a module, segment, or portion of code containing one or more executable instructions for executing specified logical function(s). In addition, in some Alternative implementations, it should be noted that functions mentioned in the blocks to occur out of order. For example, two blocks shown in succession may be performed substantially simultaneously, or the blocks may sometimes be performed in reverse order depending on their corresponding functions.

At this time, the term “unit or part” used in this embodiment refers to software or hardware components such as FPGA or ASIC, and the “unit or part” performs certain roles. However, the “unit or part” is not limited to software or hardware. The “unit or part” may be configured to be stored in an addressable storing medium or to reproduce one or more processors. Accordingly, the “unit or part” may include, for example, software components, object-oriented software components, components such as class components and task components, processors, formulas, attributes, procedures, subroutines, segments of program code, drivers, firmware, micro code, circuits, data, database, data structures, tables, arrays and variables. Functions provided in components and “units or parts” may be combined into a smaller number of components and “units or parts”, or may be further divided into additional components and “units or parts.” Furthermore, components and “units or parts” may be implemented to reproduce one or more central processing units within a device or a secure multimedia card.

Hereinafter, a base station is an entity that performs resource allocation for a terminal and may be at least one of a Node B, base station (BS), eNode B (eNB), gNode B (gNB), a radio access unit, a base station controller, or a node on a network. The terminal may include user equipment (UE), a mobile station (MS), a cellular phone, a smartphone, a computer, or a multimedia system capable of performing communication functions. In addition, the embodiment described below may be applied to other communication systems having a similar technical background or channel type as the embodiment. In addition, the embodiment may be applied to other communication systems through some modifications without significantly departing from the scope of the disclosure, at the discretion of one of ordinary skill in the art.

Terms used in the following description, such as terms for identifying a connection node, terms referring to network entities or network functions (NFs), terms referring to messages, terms referring to interfaces between network objects, and terms referring to various identification information, are provided as examples for convenience of explanation. Therefore, the disclosure is not limited to the terms described below, and other terms referring to objects having equivalent technical meaning may be used.

For convenience of explanation below, some terms and names defined in 3rd generation partnership project (3GPP) long-term evolution (LTE), Internet engineering task force (IETF) and IEEE 802 Project standards may be used. However, the disclosure is not limited by the above terms and names, and may be equally applied to systems according to other standards.

Hereinafter, various embodiments will be described in detail in order.

An O-RAN distributed unit (O-DU) may be a part of an open-RAN (O-RAN) system, typically implemented in software. In more detail, the O-DU may be a logical node hosting an RLC/MACI High-PHY layer based on lower layer functional split. An O-RAN radio unit (O-RU) may be a logical node that hosts a Low-PHY layer and RF processing based on lower layer functional split. The O-RU may perform the role of transmitting and receiving radio signals, which is the biggest feature of 3GPP's “TRP” or “RRH”.

User Equipment (UE) is a device, such as a mobile phone, that allows a user to access a network service.

An uplink (UL) refers to a traffic flow through different network components from the UE to a network and from the O-RU to the O-DU. An interface from the UE to the O-RU is wireless, while a UL traffic from the O-RU to the O-DU may take various forms (e.g., Ethernet connection) such as wireless and wired.

A downlink (DL) refers to a traffic flow through network components from the O-DU to the O-RU and from the network to the UE. A fronthaul interface from the O-DU to the O-RU may have various forms (e.g., Ethernet) such as wired or wireless, while an interface from the O-RU to the UE may be a wireless interface.

The O-RAN specification may include four planes: user plane (U-plane), control plane (C-plane), synchronization plane (S-plane), and management plane (M-plane).

The user plane (U-plane) may be a concept that includes IQ sample data transmitted between the O-DU and the O-RU.

The control plane (C-plane) is a concept that specifically refers to scheduling information, beamforming information transfer, and other real-time control between the O-DU and the O-RU, and may be distinguished from a UE's control plane.

The synchronization plane (S-plane) generally includes time and frequency synchronization configuration and information exchange, and may include other network elements in addition to the O-DU and the O-RU.

The management plane (M-plane) is a concept that represents a non-real-time management operation for the O-RU. The non-real-time management operation may be executed bidirectionally by O-RU and O-RU controllers, and the O-RU controller may reside in the O-DU or a service management and orchestration system (SMO), or may exist separately.

An M-plane interface is a link between the O-RU controller and the O-RU to exchange non-real-time management information.

The section type is a delimiter of a C-plane message format and consists of different data fields depending on the purpose, such as scheduling format, beamforming information configuration format, ACK/NACK instruction response, and LAA information exchange.

Section extension data is optional additional information attached to the end of section data in a C-plane message that mainly flow from the O-DU to the O-RU, and may transmit additional real-time control information to achieve optimization or support objectives that cannot be achieved in a normal configuration format.

A shared cell may represent a method in which multiple O-RUs operate as being included in an identical cell with one or multiple component carriers.

The O-DU and the O-RU may be classified according to the presence or absence of multiple network elements and links (data flow) as shown in Table 1 below.

TABLE 1
Cell type classification according to the number and configuration of DU and RU

| Cell type | 1 | 2A | 2B | 3 | 4 |
|---|---|---|---|---|---|
| Terms | Cell | Shared Cell | Shared Cell | Shared O-RU | Shared Cell, |
| | | | | | Shared O-RU |
| DU | 1 | 1 | 1 | 2 or more | 2 or more |
| RU | 1 | 2 or more | 2 or more | 1 | 2 or more |
| Uplan- - DL | Single link | Copy | Copy | Single link | Hybrid |
| Uplan- - UL | Single link | Combine | Multi-link | Single link | Hybrid |

Starting from the premise of an acceptable configuration without additional implementation and major changes to the UE, basically, the UE does not distinguish between shared cells and non-shared cells and recognizes them as existing cells. Therefore, regardless of the cell type, the identity of a cell is maintained as one. When the base station consists of multiple O-RUs, an excellent propagation environment may be provided by minimizing interference between radio signals such as a broadcasting channel such as System information block (SIB) 1 and a control channel such as group common PDCCH provided as a single layer within the cell.

However, in a shared cell, some signals, such as synchronization signal (SS)/physical broadcast channel (PBCH) and channel state information-reference signal (CSI-RS), may be allocated to O-RUs individually or in groups to support position and selective operation. Therefore, individual O-RUs in a shared cell are not intended to always behave the same.

In terms of O-DU, cell type 2A (shared cell) has basically the same operating principle as cell type 1. However, due to the configuration of multiple O-RUs, differences occur in expected performance of a cell and requirements for cell configuration. In terms of radio signal quality, there is an increase in noise power proportional to the number of O-RUs in a UL signal. In terms of message handling, like cell type 1, all network entities process them as a single message, and thus, a function of copying a DL directional message and combining an UL directional message in the middle of a link between the O-DU and the O-RU is required. Combine may be a concept that includes expressions such as sum, aggregate, and add. In O-RAN, a fronthaul multiplexer (FHM) or cascade O-RU is defined as a network node responsible for the function.

In an FHM mode, a shared cell may be configured to deploy an FHM function between at least one O-DU and multiple O-RUs. The FHM function may perform copy and combine functions, and like a general O-RU, may also support an LLS fronthaul. Combination may include expressions such as combine, sum, aggregate, and add. Multiple O-RUs connected to the FHM may all share one cell, and may be designed to be divided into multiple cells and shared by group.

As an example, a cascade mode may be configured in such a way that there is one O-RU directly connected to the O-DU and other O-RUs are connected in series to this O-RU.

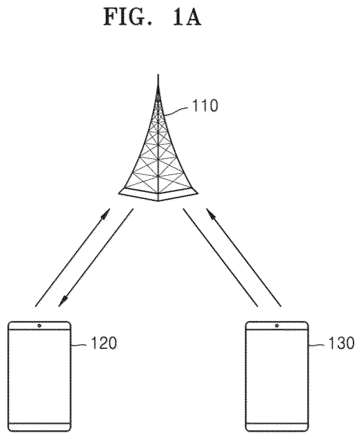

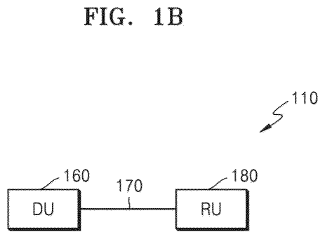

FIG. 1A is a view of a wireless communication system according to various embodiments. FIG. 1A illustrates a base station 110, a first terminal 120, and a second terminal 130 as some of nodes that use a wireless channel in the wireless communication system. FIG. 1A shows only one base station, but other base stations identical or similar to the base station 110 may be further included.

The base station 110 is a network infrastructure that provides radio access to the terminals 120 and 130. The base station 110 has coverage defined as a certain geographic area based on a distance over which signals can be transmitted. The base station 110 may be referred to as “access point (AP)”, “eNodeB (eNB)”, “5th generation node (5G node)”, “next generation nodeB (gNB)”, “wireless point”, “transmission/reception point (TRP)”, or other terms with equivalent technical meaning.

Each of the terminals 120 and 130 is a device used by a user and communicates with the base station 110 through a wireless channel. A link from the base station 110 to the first terminal 120 or second terminal 130 is called a downlink (DL), and a link from the first terminal 120 or the second terminal 130 to the base station 110 is called an uplink (UL). In addition, the first terminal 120 and the second terminal 130 may communicate with each other through a wireless channel. In some cases, at least one of the first terminal 120 and the second terminal 130 may be operated without user involvement. In other words, at least one of the first terminal 120 and the second terminal 130 is a device that performs machine type communication (MTC) and may not be carried by a user. Each of the first terminal 120 and the second terminal 130 may be referred to as “user equipment (UE)”, “customer premises equipment (CPE)”, “mobile station”, “subscriber station”, “remote terminal”, “wireless terminal”, “electronic device”, “user device”, or other terms having equivalent technical meaning.

Conventionally, in a communication system with a relatively large cell radius of base stations, each base station is installed to include functions of a digital processing unit (or digital unit (DU)) and a radio frequency (RF) processing unit (or radio unit (RU)). However, as higher frequency bands are used in 4th generation (4G) and/or later communication systems and the cell radius of base stations becomes smaller, the number of base stations to cover a specific area increases, and an installation cost burden on an operator to install the increased number of base stations increases. In order to minimize the installation cost of a base station, a structure has been proposed in which the DU and the RU of the base station are separated, one or more RUs are connected to one DU through a wired network, and one or more geographically distributed RUs are deployed to cover a specific area.

FIG. 1B is a view illustrating an example of a fronthaul structure according to functional split of a base station according to various embodiments. A fronthaul refers to a link between entities between a wireless LAN and the base station, unlike a backhaul between the base station and a core network.

Referring to FIG. 1B, the base station 110 may include a DU 160 and an RU 180. The fronthaul 170 between the DU 160 and the RU 180 may be operated through an Fx interface. For operation of the fronthaul 170, for example, an interface such as enhanced common public radio interface (eCPRI) or radio over Ethernet (ROE) may be used. As communication technology develops, mobile data traffic increases, and

accordingly, a bandwidth requirement for a fronthaul between a DU and an RU increases significantly. In deployment such as a centralized/cloud radio access network (C-RAN), the DU may be implemented to perform functions for packet data convergence protocol (PDCP), radio link control (RLC), and media access control (MAC), and the RU may be implemented to further perform functions for a PHY layer in addition to an RF function.

The DU 160 may be responsible for an upper layer function of a wireless network. For example, the DU 160 may perform a function of an MAC layer and a portion of the PHY layer. A portion of the PHY layer is performed at a higher level from among the functions of the PHY layer and may include, for example, channel encoding (or channel decoding), scrambling (or descrambling), modulation (or demodulation), or layer mapping (or layer demapping). According to an embodiment, when the DU 160 complies with an O-RAN standard, the DU 160 may be referred to as an O-RAN DU (O-DU). The DU 160 may be represented as a replacement for a first network entity for a base station (e.g., gNB) in embodiments, as needed.

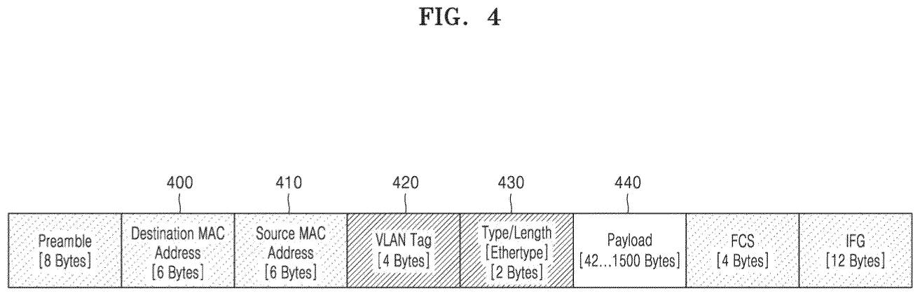

The RU 180 may be responsible for a lower layer function of a wireless network. For example, the RU 180 may perform a portion of the PHY layer and an RF function. A portion of the PHY layer is performed at a relatively lower level than the DU 160 from among the functions of the PHY layer and may include, for example, IFFT conversion (or FFT conversion), CP insertion (CP removal), and digital beamforming. An example of this specific functional split will be described in detail in FIG. 4. The RU 180 may be referred to as “access unit (AU)”, “access point (AP)”, “transmission/reception point (TRP)”, “remote radio head (RRH)”, “radio unit (RU)”, or other terms having equivalent technical meaning. According to an embodiment, when the RU 180 complies with an O-RAN standard, the RU 180 may be represented as a replacement for a second network entity (e.g., another FHM) for a base station (e.g., gNB) in embodiments, as needed.

In fronthaul communication between the DU 160 and the RU 180, the RU 180 needs to continuously perform radio transmission and reception specified in 3GPP TS within an error range specified for time and frequency resources (e.g., frequency time error, time alignment error, etc.). To this end, timing and latency of the network infrastructure are managed for each network element, and in particular, DU and RU that handle physical layer signal processing require strict timing control and high accuracy. Because functional split option 7 performs signal processing on a per-symbol basis, IQ data corresponding to each symbol and its processing information need to be transferred between the DU 160 and RU 180 before certain latency. A message arrival time may have a relationship as shown in the formula below, which is determined by a transmission time and delay.

$$Transmission point in time ( window ) + delay time = arrival point in time ( window )$$

$$Transmit widnow + transport delay <= receive window$$

Usually, there is a DU's fixed timing processing method that secures a sufficient margin for transmission delay based on timing of the RU 180, and a DU's dynamic timing processing method that takes advantage of an additional time secured by varying timing of message transmission and reception in response to a fronthaul transmission delay. The processing method is determined by the DU 160 because it depends on a message timing management capability of the DU 160. Because it is generally advantageous for the RU 180 to process in the shortest period of time with optimal resources, the RU 180 provides a delay profile according to a certain standard. This standard can be sub-carrier spacing, bandwidth, fronthaul (FH) line rate, buffer depth, transport flow, etc. Because there are too many parameters between the DU 160 and the RU 180 for delay management of messages, optimization based on consultation between vendors based on use cases is generally expected, rather than a convergence process based on general requirements and relationships. Even if a dynamic timing processing method of the DU 160 is used, this means a dynamic change according to a use case and deployment, and does not mean a dynamic change to a delay that changes dynamically in an already configured cell. It is possible to expand the method to respond semi-statically while accompanied by service deterioration, but there is currently no significant advantage.

O-RAN message timing is managed so that the DU 160 and RU 180 may transmit and receive data smoothly in relation to a transport delay. A UL combining function of U-plane message for FHM and Cascade O-RU may operate based on ta3-prime-max based on the current reference timing tul=0. Ta3-prime-max may be determined by considering Ta4-max and FH transport delay in the DU.

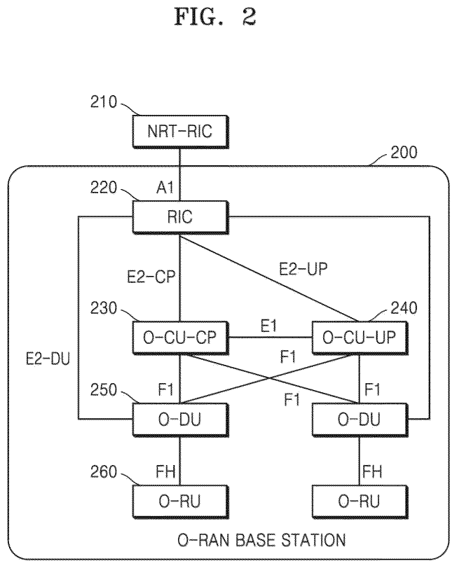

FIG. 2 is a view of an O-RAN network system according to an embodiment. According to FIG. 2, an O-RAN network is a network that logically separates functions of eNB and gNB of existing 4G and 5G systems, and may be defined as a non-real-time (NRT)-RAN intelligent controller (RIC) 210, an RIC 220 within an O-RAN base station 200, O-CU-CP 230, O-CU-UP 240, O-DU 250, O-RU 260, etc. in an O-RAN related standard. The NRT-RIC 210 is a logical node that enables non-real-time control, optimization of RAN elements and resources, model training and updates, etc. The RIC 220 is a logical node that centrally deploys servers in one physical location and enables near-real-time control and optimization of RAN elements and resources based on data collected from the O-DU 250, the O-CU-CP 230, the O-CU-UP 240, etc. through an E2 interface. The O-CU including the O-CU-CP 230 and the O-CU-UP 240 is a logical node that provides functions of radio resource control (RRC), service data adaptation protocol (SDAP), and packet data convergence protocol (PDCP). The O-CU-CP 230 is a logical node that provides functions of a C-plane portion of the RRC and PDCP, and the O-CU-UP 240 is a logical node that provides functions of a U-plane portion of the SDAP and PDCP. The O-CU-CP 230 may be connected to an access and mobility management function (AMF) included in a 5G network (5G core) and an NGAP interface. The O-DU 250 is a logical node that provides functions of RLC, MAC, and high physical layer (high-PHY), and the O-RU 260 connected to the O-DU 250 is a logical node that provides low-PHY functionality and RF processing. In FIG. 2, each logical node is shown as a single logical node, but a plurality of logical nodes are also possible. For example, multiple O-RUs 260 may be connected to one O-DU 250, and multiple O-DUs 250 may be connected to one O-CU-UP 240.

The disclosure is not limited by the name of each node described above, and the configuration of the disclosure may be applied to any logical node or entity that performs the function described above. In addition, the logical node may be physically located in the same location or a different location, and its function may be provided by the same physical device (e.g., processor, control unit, etc.) or a different physical device. For example, the function of at least one logical node described above may be provided through virtualization in one physical device. Hereinafter, an O-DU may be expressed interchangeably with a DU, and an O-RU may be expressed interchangeably with an RU.

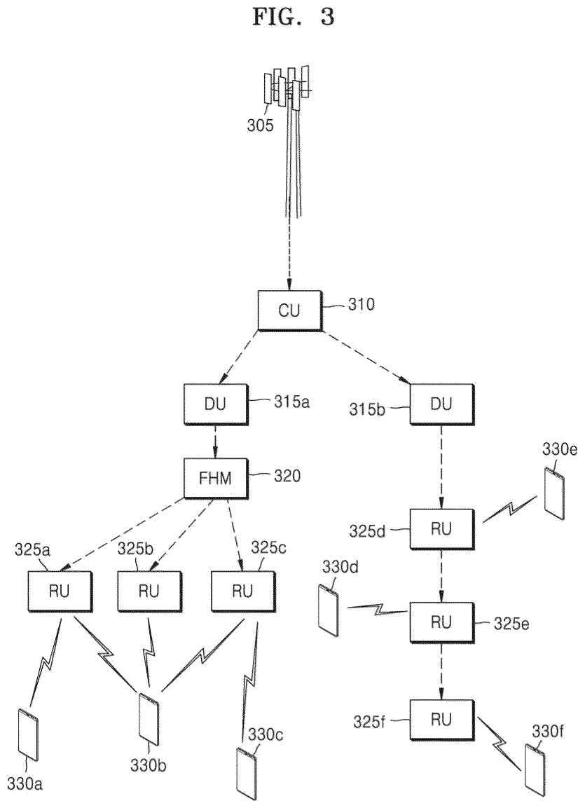

FIG. 3 is a view of a structure of an O-RAN wireless communication system according to an embodiment. The wireless communication system may include a base station 305 and at least one UE (330a, 330b, . . . , 330f). The base station may include a CU 310, at least one DU 315a or 315b, an FHM 320, and at least one RU (325a, 325b, . . . , 325f). The CU, DU, FHM, and RU may all be included in a base station or exist as entities with separate functions.

In an embodiment, the wireless communication system may be a radio access network (RAN) such as an O-RAN. The RAN may include connection between UE and a network including a base station. The O-RAN may include all of functions and components within the RAN and may interoperate with other functions or components. Like a traditional RAN structure, the O-RAN may also use a CU/DU split structure. The RU may generally have functions for transmitting, receiving, amplifying, and digitizing a radio frequency signal. In an embodiment, the RU may be located near an antenna and the DU. The CU may be located closer to a core network. The FHM may serve as an interface between the RU and the DU, and may multiplex or demultiplex information received from the RU before providing information to the DU. The CU 310, DU, FHM, and RU may be expressed as O-CU, O-DU, O-FHM, and O-RU, respectively.

In an O-RAN architecture, a shared cell structure may include an RU combining an I/Q sample to an incoming sample before transmitting the I/Q sample from the RU to the DU. In the O-RAN architecture utilizing CU/DU split, the structure may be defined in two modes.

A first mode is an FHM mode, and the FHM 320 may retrieve compressed information along with the I/Q sample through signaling from all O-RUs 325a, 325b, and 325c connected to the FHM 320. A plurality of O-RUs are connected to the FHM, and each RU may be associated with one or more UEs or perform wireless communication.

A second mode may be defined as a cascade mode (or a cascade O-RU mode). Cascade O-RUs 325d and 325e may retrieve compressed information along with the I/Q sample through messaging from a southbound node O-RU (e.g., trailing O-RU or downstream O-RU). An upstream O-RU may perform combining to transmit the I/Q sample to the next RU or DU.

FIG. 4 is a view of a structure of an Ethernet message according to an embodiment. A destination MAC address 400 in a header of the Ethernet message may indicate a public address of an RU in a case of DL, and may indicate a public address of a specific port of a channel card of a DU (the channel card may perform an MAC layer operation responsible for scheduling, a high-PHY operation, and an operation to convert a data format according to an interface between the RU and the DU) in a case of UL. A source MAC Address 410 may indicate the RU in a case of UL, and may indicate a public address of a specific port of the channel card of the DU in a case of DL.

A virtual LAN (VLAN) Tag 420 has a size of 4 bytes and allows management of C-plane, U-plane, or S-plane messages by mapping them to respective VLAN tags. A tag protocol identifier (TPID) included in the VLAN Tag 420 may be set to 16 bits and may be set to a value of 0x8100 to identify a frame as an IEEE 802.1Q tag frame. This field is located in the same position as that of an Ethertype/Length field in an untagged frame, so it can be used to distinguish an untagged frame from regular frames. Tag control information (TCI) included in the VLAN Tag may also be set to 16 bits and may include the following three fields. Priority code point (PCP) is 3 bits and may express priority of frames. A drop eligible indicator (DEI) may be set to 1 bit and is used separately or in combination with the PCP, and identifies frames that are desirable to be removed when traffic becomes congested. A VLAN identifier (VID) may be set to 12 bits and is a field that indicates which frame a VLAN belongs to. All values except reserved values 0x000 and 0xFFF may be used as VLAN identifiers, and up to 4,094 VLANs may be allowed. A reserved value 0x000 indicates that a frame does not belong to any VLAN. In this case, 802.1Q only specifies a priority and this priority may be referenced as a priority tag. Because Type/Length (Ethertype) is for eCPRI, it can be set to a fixed value of 0xAEFE.

A payload 440 may include a message according to each plane format, including an eCPRI header, as shown in FIG. 4. Content of each field or information of the Ethernet message described in relation to FIG. 4 does not necessarily have to be included all fields, and the disclosure may be performed by omitting the content or/and adding other fields as necessary.

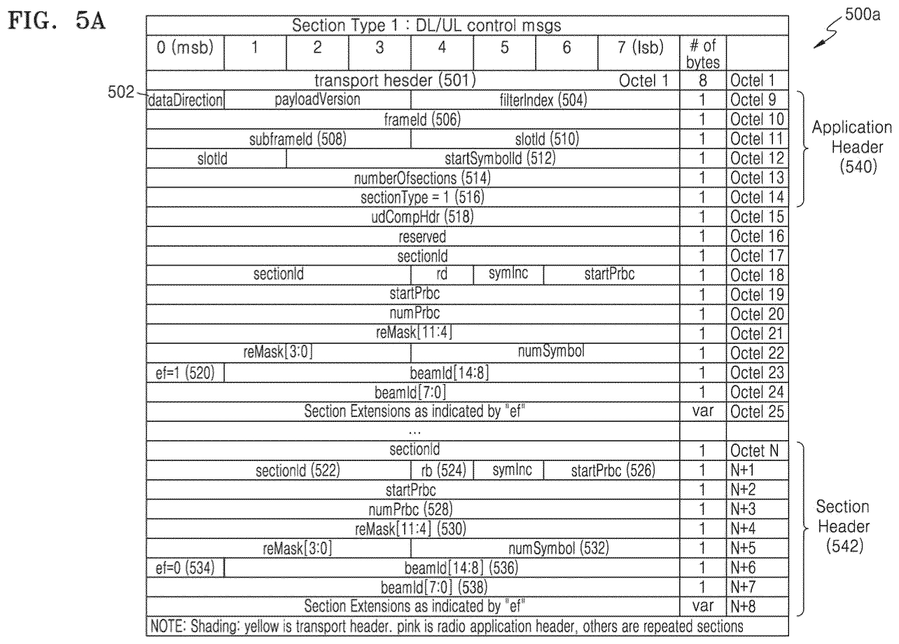

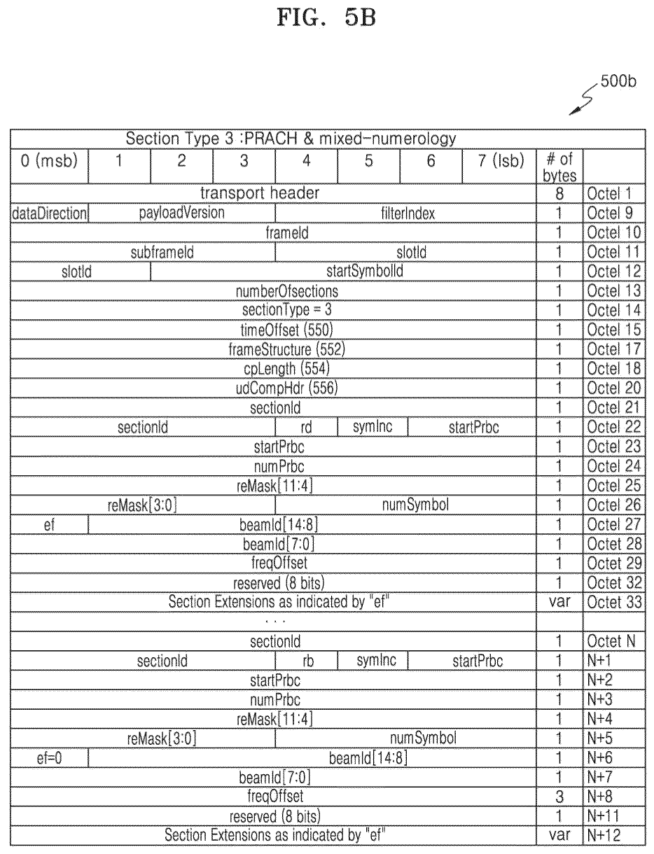

FIGS. 5A and 5B are views illustrating an example of a C-plane message according to an embodiment. FIG. 5A may show a C-plane structure of section type 1, and FIG. 5B may show a C-plane structure of section type 3.

First, looking at each field in FIG. 5A, transport header 501 may include an eCPRI header shown in FIG. 4 or information according to IEEE-1914.3. dataDirection 502 indicates the direction of a U-Plane message, wherein 0 may indicate UL and 1 may indicate a DL. filterIndex (504 indicates a channel filter of an RU and may be set to 0x1. frameId 506 may indicate a specific frame in units of 10 ms. SubframeId 508 may indicate a specific subframe in units of 1 ms within a corresponding frame. slotId 510 may indicate a specific slot within a corresponding frame.

numberOfsections 514 may indicate the number of sections indicated by a corresponding message. In the case of SectionType 516, one C-plane message may have only one section type. In this example, the SectionType 516 may indicate section type 1. udCompHdr 518 may indicate an IQ bit width (bit) and compression method for IQ data in all sections of a corresponding message. In more detail, upper 4 bits may be iqWidth, indicating 1 to 16 bits, and lower 4 bits may be compMeth, indicating a compression method. 502 to 518 described above are application headers 540 that can be commonly applied to a corresponding message, and may be included in a similar structure in all C-plane messages.

A C-plane message of section type 1 may include information about an arbitrary section. SectionID 522 indicates an ID of the section, which may be used to match a C-plane message and a U-plane message. rb 524 indicates which PRB (physical resource block) is used, wherein 0 may indicate that all PRBs are used, and 1 may indicate that one PRB (every other PRB) is used. StartPrbc 526 is used to indicate the first PRB of a corresponding section, and numPrbc 528 may indicate the number of PRBs in a corresponding section. reMask 530 is a bit pattern that indicates an RE (resource element) (or subcarrier) corresponding to a specific beam in a corresponding PRB, and different beams may be applied within one PRB through reMask. numSymbol 532 may indicate the number of symbols corresponding to the section. The fields described above may be referred to as a section header 542 for each section.

In addition, the C-plane message may include section extension, and whether or not the section extension is included may be indicated by ef 520. Content of each field or information described in relation to FIG. 5A does not necessarily have to be included all fields, and the disclosure may be performed by omitting the content or/and adding other fields as necessary.

Referring to FIG. 5B, transport header to sectionType are the same as in FIG. 5A, but there is a difference in the next field. Timeoffset 550, framestructure 552, cpLength 554, and udCompHdr 556 are fields that can be checked in C-plane of section type 3. Timeoffset 550 defines a time offset from the start of a slot to the start of a cyclic prefix (CP). Framestructure 552 defines a frame structure, where the first 4 bits define the size of FFT/iFFT used for processing all IQ data associated with a C-plane message, and the remaining 4 bits define subcarrier spacing and the number of slots per 1 ms subframe. cpLength 554 indicates a length of the cyclic prefix. udCompHdr 556 defines a compression method and an in-phase and quadrature (IQ) bitwidth for user data in a data section. Because most of the other fields are similar to FIG. 5A, their description will be omitted.

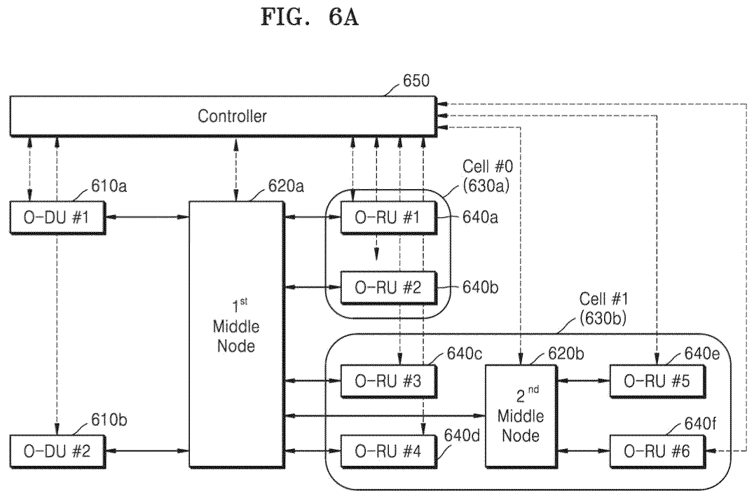

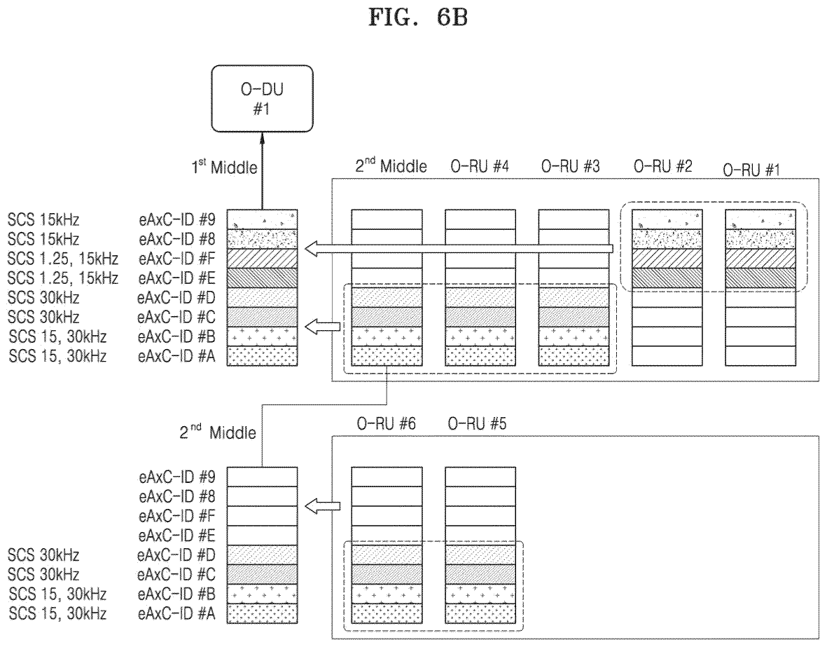

FIG. 6A is a view of a structure of an O-RAN base station including a middle node according to an embodiment.

Referring to FIG. 6A, an O-RAN base station (or network) 600 may include at least one O-DU 610a or 610b, middle nodes 620a and 620b, at least one O-RU (640a, 640b, . . . , 640f), and a controller 650.

The at least one O-DU 610a or 610b may also be called a northbound node centered on the first middle node 620a. The middle nodes 620a and 620b may be used interchangeably with an FHM 620a, a cascade FHM (not shown), or a cascade O-RU 620B. The at least one O-RU (640a, 640b, . . . , 640f) may be used interchangeably with a southbound node centered on the first middle node 620a. The controller 650 may have functions included in the O-DU 610a or 610b, or may exist as a separate device.

Referring to FIG. 6A, the controller 650 may perform direct communication with the at least one O-DU 610a or 610b, the middle nodes 620a and 620b, and the at least one O-RU (640a, 640b, . . . , 640f). The controller 650 may communicate an M-plane message with the at least one O-DU 610a or 610b. The controller 650 may communicate an M-plane message with the middle nodes 620a and 620b. The at least one O-DU 610a or 610b may communicate a C/U-Plane message with the first middle node 620a. The at least one O-DU 610a or 610b may communicate a C/U-Plane message directly with the at least one O-RU (640a, 640b, . . . , 640f). The middle node may communicate with at least one O-RU included in at least one cell (cell #0 or cell #1) 640a or 640b. The first middle node 620a transmits the M-plane and C/U-plane messages received from the at least one O-DU 610a or 610b or the controller 650 to the at least one O-RU (640a, 640b, . . . , 640f). At this time, the first middle node 620a may copy an identical message and transmit it to O-RUs included in each of the cells. For example, an identical message may be copied from the first middle node 620a and transmitted to O-RU #1 640a and O-RU #2 640b included in cell #0 630a, respectively. Different messages may be transmitted to cell #0 630a and cell #1 630b from the first middle node 620a, respectively. According to an embodiment, the second middle node 620b may be included inside the cell #1 630b. In this case, the second middle node 620b includes an O-RU southbound from the second middle node 620b, and may copy and transmit a message sent from the upper level to the corresponding O-RU. For example, cell #1 630b includes the second middle node 620b, and the second middle node 620b may copy and transmit data received from the first middle node 620a to O-RU #5 640e and O-RU #6 640f located southbound.

Referring to FIG. 6A, the at least one O-RU (640a, 640b, . . . , 640f) may transmit a U-plane message to the first middle node 620a based on data received from a terminal.

The first middle node 620a may combine messages received from the at least one O-RU (640a, 640b, . . . , 640f). The combination may include expressions such as combine, sum, aggregate, and add. The first middle node 620a may combine messages received from the at least one O-RU (640a, 640b, . . . , 640f) and transmit them to the at least one O-DU 610a or 610b. At this time, the first middle node 620a may perform combining on data received from O-DUs included in an identical cell. According to an embodiment, the second middle node 620b may be included inside the cell #1 630b. In this case, the second middle node 620b includes an O-RU southbound from the second middle node 620b, and may combine messages received from the O-RU and transmit them to an upper level. For example, according to a cascade structure in cell #1 630b, the second middle node 620b may combine data received from O-RU #5 640e and O-RU #6 640f located at a lower level and transmit the data to the first middle node 620a at an upper level. The combination may include expressions such as combine, sum, aggregate, and add. The first middle node 620a may combine data received from the second middle node 620b and data received from O-RU #4 640d and transmit the data to the O-DU 610a or 610b.

FIG. 6B is a view illustrating a situation in which pieces of uplink data transmitted from multiple O-DUs included in multiple cells are combined according to an embodiment.

FIG. 6B may show that the first middle node described in FIG. 6A combines data from O-RU #1 640a and O-RU #2 640b included in cell #0 630a, and combines data from O-RU #3 640c, O-RU #4 640d, and the second middle node 620b included in cell #1 630b. The second middle node 620b may operate as a cascade O-RU that combines data from O-RU #5 640e and O-RU #6 640f, which are southbound nodes.

Referring to FIG. 6B, the data of O-RU #1 and O-RU #2 included in cell #0 has data in extended antenna-carrier (eAxC) identifier (ID) #F, eAxC_ID #8, and eAxC_ID #9. eAxC_ID #8 and eAxC_ID #9 are composed of the same SCS 15 kHz, and eAxC_ID #F is composed of SCS 1.25 and 15 kHz and may include multiple SCS. eAxC_ID #F may be a section type 3 message. Because the first middle node includes a single SCS for each single eAxC_ID, data combination may be performed using a conventional method.

However, the data of O-RU #3, O-RU #4, and the second middle node included in cell #1 has data in eAxC_ID #A, eAxC_ID #B, eAxC_ID #C, and eAxC_ID #D, wherein eAxC_ID #C and eAxC_ID #D are composed of the same SCS 30 KHz, and eAxC_ID #A and eAxC_ID #B are composed of SCS 15 and 30 kHz and may include multiple SCSs.

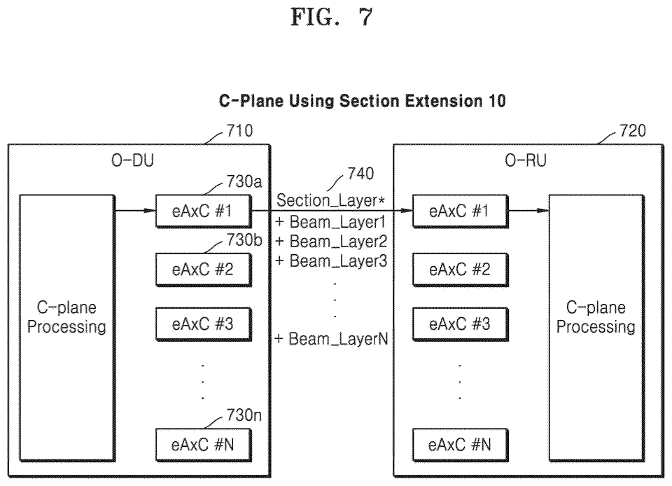

FIG. 7 is a view illustrating a C-plane using section extension 10 according to an embodiment.

In general, when transmitting C-plane and/or U-plane messages to an O-RU 720, an O-DU 710 may process each layer or spatial stream using a unique eAxC_ID. In various situations, information included in a C-plane message for multiple spatial streams may be the same or configured similarly. In other words, multiple C-plane messages may all be set to have an identical value. For example, single user multiple input multiple output (MIMO) allocation with N layers may have the same values for startprbc, Numprbc, reMask, and numsymbol values in a section header for all N C-plane messages. In this case, in Section extension (SE) 10, multiple C-plane messages may be replaced with one C-plane message using a representative eAxC_ID 730a set through an M-plane message for multiple eAxC_IDs 730a, 730b, . . . , 730n. SE 10 may be selectively used when capability information of the O-RU 720 includes information indicating that it supports SE 10.

Referring to FIG. 7, the O-DU 710 may set the representative eAxC_ID 730a for an eAxC_ID group including the multiple eAxC_IDs 730a, 730b, . . . , 730n. When the representative eAxC_ID 730a is set, the O-DU may transmit one C-plane message addressed to the representative eAxC_ID 730a with SE 10 instead of the multiple C-plane messages corresponding to the multiple eAxC_IDs 730a, 730b, . . . , 730n. Upon receiving the C-plane message including SE 10, the O-RU 720 may apply the C-plane message to all endpoints indicated by the representative eAxC_ID 730a and perform the same operation as receiving multiple C-plane messages when SE 10 is not applied.

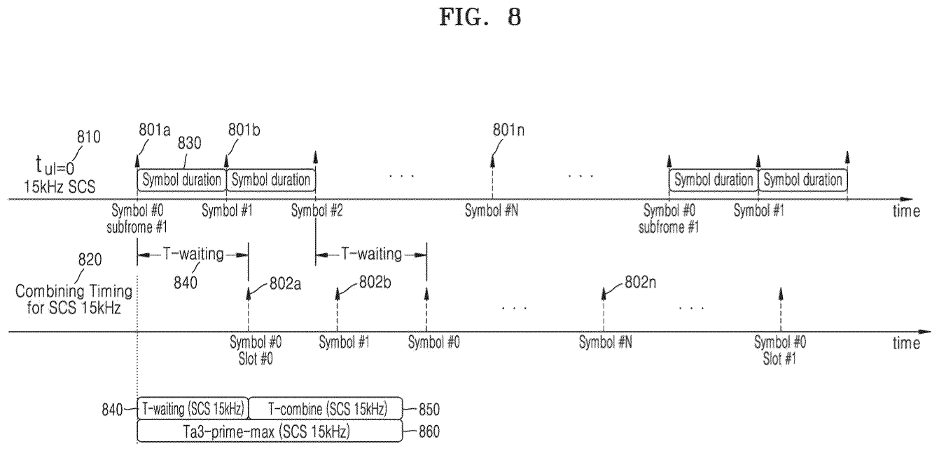

FIG. 8 is a view illustrating a method in which a middle node creates a trigger and performs combining, according to an embodiment.

FIG. 8 may illustrate a method for a middle node to determine timing for combining uplink data when the SCS is 15 kHz. The method of FIG. 8 may represent a method performed in the middle node in FIGS. 1A to 7.

Referring to FIG. 8, it can be seen that a diagram 810 shows timing at which uplink data in a time domain is received when reference timing tul=0. Symbol timings 801a, 801b, . . . , 801n are triggered at regular intervals depending on a value of SCS, and the interval between each symbol timing may be referred to as symbol duration 830. Uplink data may be received from a lower node to the middle node during the symbol duration 830.

A diagram 820 showing combining timing shows timing at which the middle node actually starts combining uplink data. Combine trigger timing #0 802a is timing corresponding to symbol timing #0 801a and can be determined as follows.

The middle node may consider a timing value (i.e., Ta3′-max) 860 at which data received from a controller or an O-DU through an M-plane needs to be transmitted from the middle node to the O-DU. The timing value may be determined corresponding to the SCS. The middle node that receives the uplink data may calculate Ta3′-max 860 from each symbol timing 801a, and may use T-combine 850, a time required for the middle node to combine data to transmit data at corresponding timing, to determine combining timings 802a, 802b, . . . , 802n, which are timings at which combination needs to be initiated. Once the combining timings 802a, 802b, . . . , 802n are determined, a waiting time (T-waiting) 840 may be set from the symbol timings 801a, 801b, . . . , 801n to the combining timings 802a, 802b, . . . , 802n. When one eAxC_ID consists of only one SCS, the middle node may perform combining by matching the eAxC_ID and SCS and paging data for each eAxC_ID.

For example, referring to FIG. 8, the middle node may receive the timing value (i.e., Ta3′-max) 860 at which data needs to be transmitted from the corresponding middle node to the O-DU when the SCS is 15 kHz. The middle node may determine the combining timings 802a, 802b, . . . , 802n by 1 corresponding the time (T-combine) 850 required to combine data when the SCS is 15 kHz to Ta3′-max 860. In addition, the waiting time (T-waiting) 840 for combining may be determined using the determined combining timings 802a, 802b, . . . , 802n and the symbol timings 801a, 801b, . . . , 801n.

The middle node may start combining at the most efficient and appropriate time by utilizing a timing value at which data received from the controller or O-DU through the M-plane needs to be transmitted from the middle node to the O-DU.

TABLE 2

| SCS | | | | | | |
|---|---|---|---|---|---|---|
| (sub-carrier | | Symbol Duration | | | | |
| spacing) | | Without CP | | | Air Technology | Channel |
| 1.25 | KHz | 800 | μs | 24576 · Ts | LTE, 5G NR, | PRACH |
| | | | | | NB-IoT | |
| 3.75 | KHz | 266.6 | μs | 8192 · Ts | NB-IoT | NPUSCH, |
| | | | | | | NPRACH |
| 5 | KHz | 133.3 | μs | 6144 · Ts | LTE | PRACH |
| 7.5 | KHz | 133.3 | μs | 4096 · Ts | LTE, 5G NR | PRACH |
| 15 | KHz | 66.6 | μs | 2048 · Ts | LTE, 5G NR | PUxCH, |
| | | | | | | NPUSCH |
| 30 | KHz | 33.3 | μs | 1024 · Ts | 5G NR | PUxCH, SRS |
| 60 | KHz | 16.65 | μs | 512 · Ts | 5G NR | PUxCH, SRS |
| 120 | KHz | 8.325 | μs | 256 · Ts | 5G NR | PUxCH, SRS |
| 240 | KHz | 4.16 | μs | 128 · Ts | 5G NR | PUxCH, SRS |
| 480 | KHz | 2.08 | μs | 64 · Ts | 5G NR | PUxCH, SRS |
| 960 | KHz | 1.04 | μs | 32 · Ts | 5G NR | PUxCH, SRS |

Checking the table above, it can be seen that the SCS is divided into 10 and that symbol duration decreases as the SCS increases. Ts may represent 1/30.72 MHz. 1.25 KHz and 3.75 kHz are mainly used in section type 3 signals. However, configurations of the SCS are not limited to the table above and may be set differently depending on configurations of a user, vendor, standard, etc.

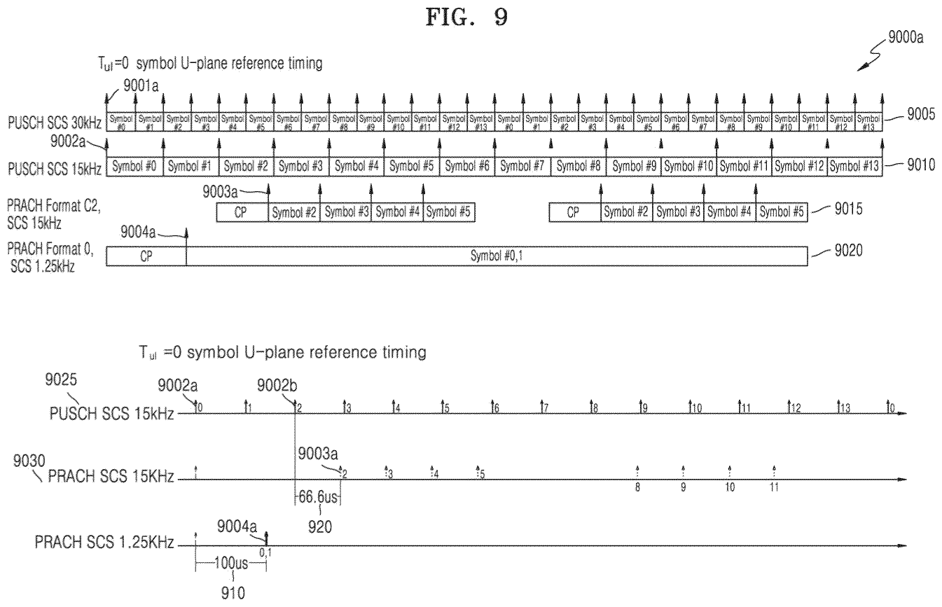

FIG. 9 is a view illustrating a method of determining combining timing for a plurality of symbol reference timings, according to an embodiment.

The method in FIG. 9 may represent the method performed in the middle node in FIGS. 1A to 8.

FIG. 9 is a view illustrating how the middle node determines combining timing for multiple SCSs when one eAxC_ID includes multiple SCSs and processes them separately.

Referring to 9000a in FIG. 9, an uplink message that the middle node receives from a southbound node may include PUSCH 9005 with an SCS of 30 kHz, PUSCH 9010 with an SCS of 15 kHz, PRACH format C2 9015 with an SCS of 15 kHz, and PRACH format 0 9020 with an SCS of 1.25 kHz. In this case, multiple SCSs may be included in an identical eAxC_ID. PUSCH 9005 with the SCS of 30 KHz may have U-plane reference timings 9001a, 9001b, . . . according to a size of the SCS when Tul=0, PUSCH 9010 with the SCS of 15 kHz may have U-plane reference timings 9002a, 9002b, . . . according to a size of the SCS when Tul=0, PRACH format C2 9015 with an SCS of 15 KHz may have U-plane reference timings (or symbol reference timings) 9003a, 9003b, . . . including CP according to a size of the SCS, and PRACH format 0 9020 with the SCS of 1.25 kHz may have U-plane reference timing 9004a according to a size of the SCS. Symbol duration between each U-plane reference timing may be used as a timing value for receiving uplink data. According to an embodiment, U-plane reference timing may use fixed symbol timing for a message scheduled by section type 1, and may use floating symbol timing for a message scheduled by a section type 3 C-plane.

Symbol reference timing of the U-plane indicated by a section type 1 C-plane message may be identified based on timing parameters (e.g., frameId, subframeId, SlotId, or symbolid). The symbol reference timing of the U-plane indicated by the section type 3 C-plane message may be identified by slotId, startSymbolid, timeoffset, cplength, framestructure, and numsymbol of a C-plane.

Before receiving an uplink message, the middle node may receive information indicating that one eAxC_ID includes multiple SCSs, and timing values (i.e., Ta3′-max and Ta3-prime-max) for transmitting data from a middle node according to an SCS used to an O-DU, from a controller or O-DU.

Referring to 9000b in FIG. 9, even if the SCS is the same for reference timing for a U-plane of a header with the same timing parameters, an error equal to the maximum symbol duration may occur as the reference timing is indicated according to a section type. For example, 9025 of 9000b is PUSCH with an SCS of 15 kHz, indicating symbol timing. In a case of 9030, symbol timings of PRACH format C2 with an SCS of 15 kHz, which is the same as 9025, and format 0 with an SCS of 1.25 kHz are shown in an identical time domain. First, in the case of PUSCH and PRACH format C2 with the same SCS, PUSCH has timing for symbol #0 and symbol #2 like 9002a and 9002b, but PRACH has timing starting from symbol #2 like 9003a. However, depending on characteristics of a section type, an error of 66.6 μs (microseconds) 920 may occur between PUSCH and PRACH even if the symbol timings are for the same symbol #2. In other words, when the middle node performs combining, if the SCS pages the same symbol at the same timing based on a symbol ID without considering the type, a PUSCH symbol and a PRACH symbol may be paged at the same time, and PUSCH may be combined because combining timing is the same. However, in the case of PRACH, not all data may be received at the corresponding timing, and because the combining timing is different, it is necessary to wait, which may result in packets being dropped or T-combine, the maximum time for combining, becoming longer. In addition, when SCSs of PUSCH and PRACH are different, a larger error may occur than when the SCSs are the same. For example, when the middle node performs combining for PUSCH with an SCS of 15 kHz and PRACH format 0 with an SCS of 1.25 kHz, if both PUSCH and PRACH are paged for combining according to the same reference timing regardless of the type, an error of 100 μs 910 occurs in PUSCH and PRACH in symbol IDs #0 and #1. When PRACH 1.25 kHz is paged at 9002a timing, packets may not be received, resulting in dropped packets, or waiting to combine PRACH packets may result in longer T-combines, resulting in longer delays.

To solve this problem, a method is required to distinguish and recognize the type of message and determine a combination trigger appropriate for the type. Hereinafter, a method of determining a section type of a message through a C-plane and determining combination trigger timing according to the section type will be proposed.

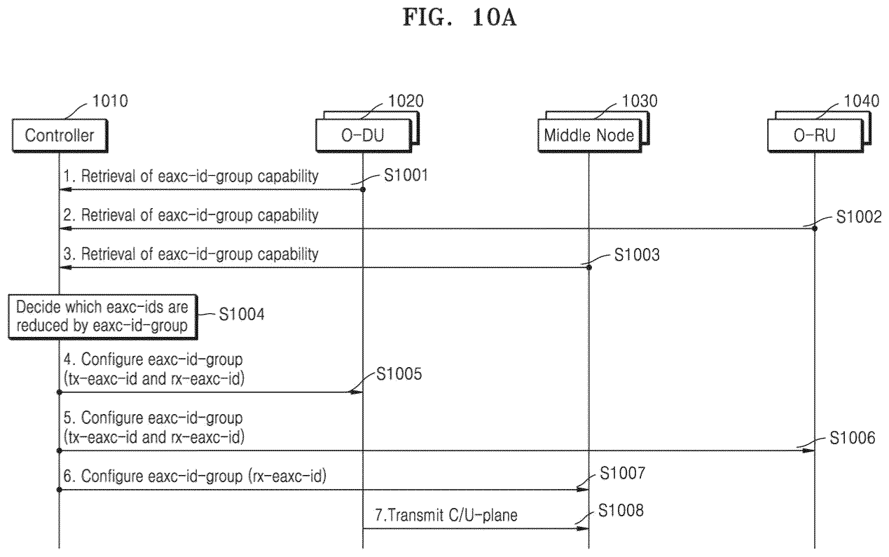

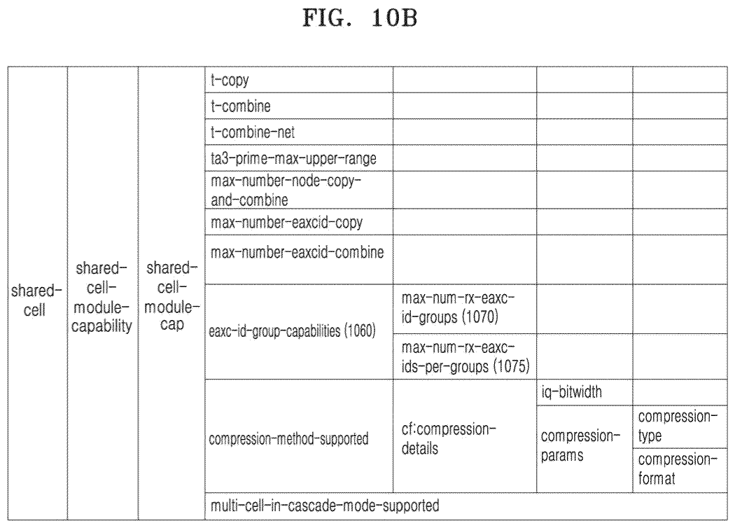

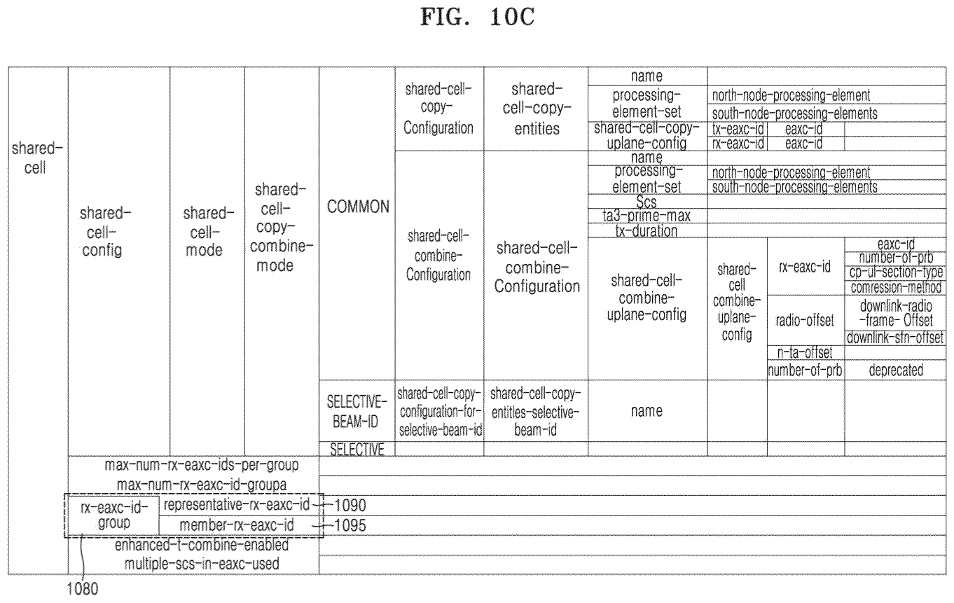

FIG. 10A is a view illustrating a process for applying Section extension 10 in a middle node, according to an embodiment. FIGS. 10B and 10C are views of a structure of a YANG model according to an embodiment.

A controller 1010, at least one O-DU 1020, middle node 1030, and at least one O-RU 1040 of FIG. 10A may be the same as the controller, O-DU, middle node, and at least one O-RU of FIGS. 1 to 9.

Before FIG. 10A, the middle node may transmit and receive information (e.g., EAXC-ID-GROUP-IN-SHARED-CELL) indicating that a shared cell may support U-plane using SE 10 with a controller.

Referring to FIG. 10A, in operation S1001, the controller 1010 may request eAxC_ID group capability information (eAxC-ID-group capability) from the O-DU 1020. When the O-DU 1020 receives a request for eAxC_ID group capability information from the controller 1010, the O-DU 1020 may transmit the information through an M-Plane message. According to another embodiment, the O-DU 1020 may periodically transmit preset eAxC_ID group capability information to the controller 1010.

In operation S1002, the controller 1010 may request eAxC_ID group capability information (eAxC-ID-group capability) from the O-RU 1040. When the O-RU 1040 receives a request for eAxC_ID group capability information from the controller 1010, the O-RU 1040 may transmit the information through an M-Plane message. According to another embodiment, the O-RU 1040 may periodically transmit preset eAxC_ID group capability information to the controller 1010.

In operation S1003, the controller 1010 may request eAxC_ID group capability information from the middle node 1030. When the middle node 1030 receives a request for eAxC_ID group capability information from the controller 1010, the middle node 1030 may transmit the information through an M-Plane message. According to another embodiment, the middle node 1030 may periodically transmit preset eAxC_ID group capability information to the controller 1010.

The eAxC_ID group capability information in operations S1001 to S1003 may include eAxC-id-group-capabilities 1060 of FIG. 10B. The eAxC-id-group-capabilities 1060 may include max-num-rx-eaxc-id-groups 1070 and max-num-rx-eaxc-ids-per-group 1075. The max-num-rx-eaxc-id-groups 1070 may indicate the maximum number of eAxC_ID groups that communication nodes (O-DU, O-RU, and middle node) may process, and the max-num-rx-eaxc-ids-per-group 1075 may indicate the maximum number of member eAxC_IDs that can be included in one group.

Referring to FIG. 10B, in the YANG model, new information, the eAxC-id-group-capabilities 1060, may be included in shared-cell-module-cap of shared-cell-module-capability of shared-cell. The eAxC-id-group-capabilities 1060 may include max-num-rx-eaxc-ids-per-group 1075, and communication may be performed through an M-plane.

In operation S1004, the controller 1010 may determine which eAxC_IDs need to be deleted from an eAxC_ID group based on the eAxC_ID group capability information received from the communication nodes (O-DU, O-RU, and middle node) in operations S1001 to S1003. In other words, when applying SE 10 in fronthaul communication between the O-DU, middle node, and O-RU, it can be determined which eAxC_IDs will be set as a group. In addition, it may be determined, among the corresponding eAxC_IDs, which eAxC_ID will be a representative eAxC_ID and which eAxC_ID will be a member eAxC_ID. The controller 1010 may configure eAxC_ID group configuration information by determining the representative eAxC_ID and member eAxC_ID.

In operation S1005, the controller 1010 may transmit the eAxC_ID group configuration information (eAxC-ID group) configured in operation S1004 to the O-DU 1020 through the M-plane. In addition, the controller 1010 may transmit tx-eAxC_ID for a downlink and rx-eAxC_ID for an uplink indicating a transmission direction to the O-DU 1020.

In operation S1006, the controller 1010 may transmit the eAxC_ID group configuration information configured in operation S1004 to the O-RU 1040 through the M-plane. In addition, the controller 1010 may transmit tx-eAxC_ID for a downlink and rx-eAxC_ID for an uplink indicating a transmission direction to the O-RU 1040.

In operation S1007, the controller 1010 may transmit the eAxC_ID group configuration information configured in operation S1004 to the middle node 1030 through an M-plane. In addition, the controller 1010 may transmit rx-eAxC_ID for an uplink indicating a transmission direction to the middle node 1030. Referring to FIG. 10C, in a Yang model, eAxC_ID group configuration information (rx-eaxc-id-group) 1080 newly included in shared-cell may include information of a representative eAxC_ID 1090 and a member eAxC_ID 1095. The middle node 1030 may receive eAxC_ID group configuration information so the middle node 1030 may respond to a case where SE 10 is applied. The group configuration information may be communicated through an M-plane.

In operation S1008, the middle node 1030 may receive a C/U-plane message from the O-DU 1020. If the middle node 1030 previously received eAxC_ID group configuration information, when receiving a C-plane message from the O-DU 1020, the middle node 1030 may identify whether the C-plane message is a grouped C-plane with SE 10 applied. When combining data received from the O-RU 1040 later, the middle node 1030, based on the identified C-plane message, may perform combining by calling all of multiple eAxC_IDs included in the received message without omission.

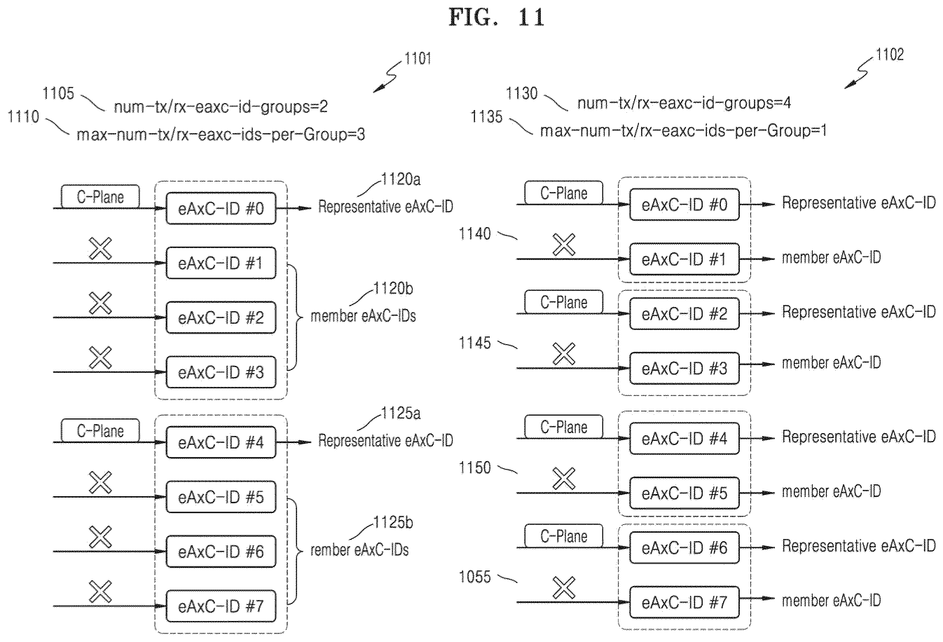

FIG. 11 is a view of a structure of an eAxC_ID group according to an embodiment.

The eAxC_ID group and eAxC_ID group information in FIG. 11 may be set to be the same as or similar to the eAxC_ID group and eAxC_ID group information described in FIGS. 10A to 10C.

FIG. 11 may show a method of processing C/U-plane in fronthaul communication when SE 10 is applied.

FIG. 11 explains how the eAxC-id-group-capabilities 1060 (max-num-rx-eaxc-id-groups 1070 and max-num-rx-eaxc-ids-per-group 1075) described in FIG. 10B is actually used and how the eAxC_ID group configuration information 1080 (representative eAxC_ID 1090 and member eAxC_ID 1095) described in FIG. 10C is configured.

FIG. 11 shows a case in which two types of eAxC_ID group capability information 1101 and 1102 are applied. The eAxC_ID group capability information 1101 and 1102 may include max-num-rx-eaxc-id-groups 1105 and max-num-rx-eaxc-ids-per-group 1110.

The max-num-rx-eaxc-id-groups 1105 may indicate the maximum number of eAxC_ID groups that communication nodes (O-DU, O-RU, and middle node) may process, and the max-num-rx-eaxc-ids-per-group 1110 may indicate the maximum number of member eAxC_IDs that can be included in one group.

In a case in which the first eAxC_ID group capability information 1101 is applied, the max-num-rx-eaxc-id-groups 1105 is 2, and the max-num-rx-eaxc-ids-per-group 1110 is 3. The middle node may transmit eAxC_ID group capability information to a controller through an M-plane message. In this case, the middle node may process a total of two eAxC_ID groups 1120(a,b) and 1125(a,b), and may process up to four of the total number of eAxC_IDs in each group. Referring to FIG. 11, for the first eAxC_ID 1120(a,b), a representative eAxC_ID 1120a is eAxC_ID #0, and member eAxC_IDs 1120b include eAxC_ID #1, #2, and #3. For the second eAxC_ID 1125(a,b), a representative eAxC_ID 1125a is eAxC_ID #4, and member eAxC_IDs 1125b include eAxC_ID #5, #6, and #7. The middle node may receive eAxC_ID group configuration information from a controller, and may identify a representative eAxC_ID and member eAxC_IDs included in the eAxC_ID group configuration information, so even if the middle node only receives the C-plane for the representative eAxC_ID later, the middle node may identify that the same C-plane may also be applied to the member eAxC_IDs. As a result, when combining uplink data, the middle node may perform data combining not only with the representative eAxC_ID but also with the member eAxC_IDs.

In a case in which the second eAxC_ID group capability information 1102 is applied, max-num-rx-eaxc-id-groups 1130 is 4, and max-num-rx-eaxc-ids-per-group 1110 is 1. The middle node may transmit eAxC_ID group capability information to a controller through an M-plane message. In this case, the middle node may process a total of four eAxC_ID groups (1140, 1145, 1150, 1155), and may process up to 2 of the total number of eAxC_IDs in each group. Referring to FIG. 11 For the third eAxC_ID 1140, a representative eAxC_ID is eAxC_ID #0, and a member eAxC_ID includes only eAxC_ID #1. For the fourth eAxC_ID 1145, a representative eAxC_ID is eAxC_ID #2, and a member eAxC_ID includes eAxC_ID #3. For the fifth eAxC_ID 1150, a representative eAxC_ID is eAxC_ID #4, and a member eAxC_ID includes only eAxC_ID #5. For the sixth eAxC_ID 1155, a representative eAxC_ID is eAxC_ID #6, and a member eAxC_ID includes eAxC_ID #7.

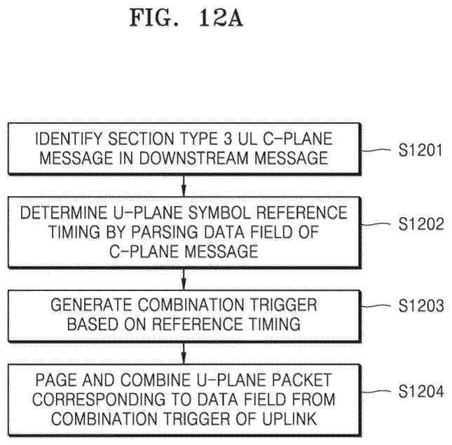

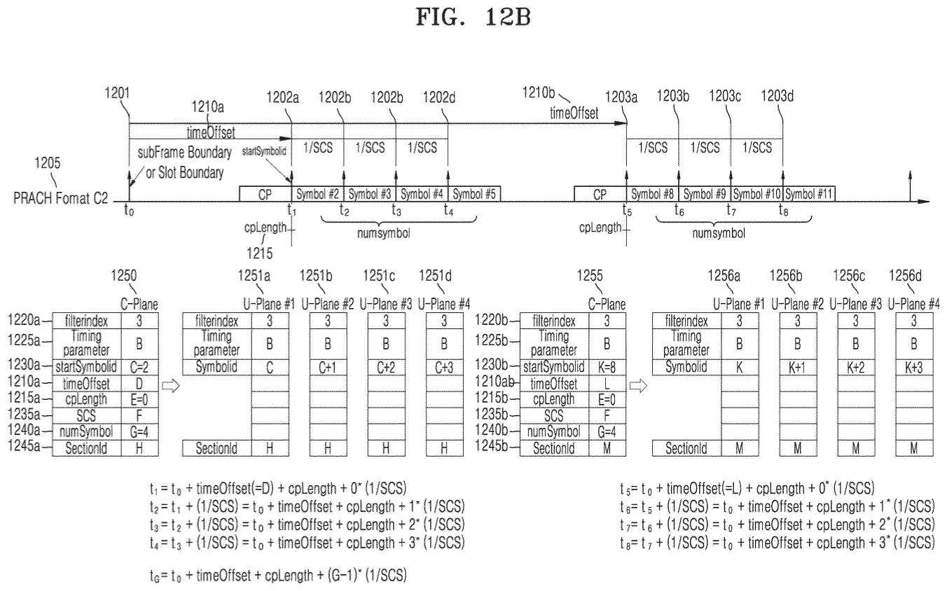

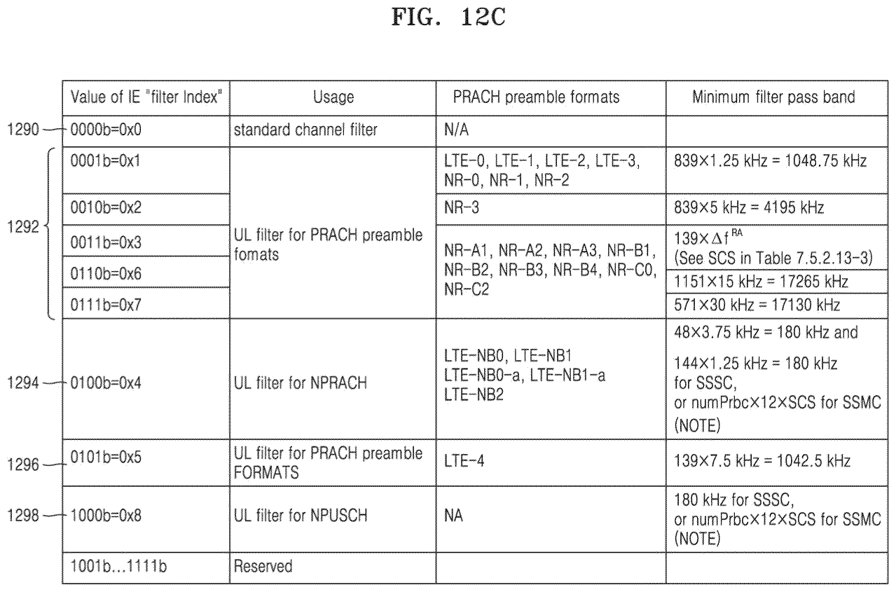

FIG. 12A is a flowchart illustrating a method by which a middle node combines uplink packets, according to an embodiment. FIG. 12B is a view illustrating a method of determining symbol timing of a PRACH message, according to an embodiment. FIG. 12C is a table illustrating filterIndex according to an embodiment.

A controller, middle node, O-DU, and O-RU of FIG. 12A may be the same or similar to the controller, middle node, O-DU, and O-RU described in FIGS. 1 to 11 of the disclosure.

FIG. 12A may be an operation performed by the middle node. The middle node may receive multiple C/U-plane messages through a downstream message.

In operation S1201, the middle node may identify a section type 3 UL C-plane message from among various messages included in the downstream message. When the section type 3 UL C-plane message is identified, if the middle node applies normal symbol reference timing when communicating a U-plane message corresponding to the C-plane message, timing errors may occur and various problems may occur. Therefore, the middle node may identify whether symbol timing for the section type 3 UL C-plane message needs to be calculated in case to identify the section type 3 UL C-plane message.

In operation S1202, the middle node may determine U-plane symbol reference timing by parsing the received section type 3 UL C-plane message. The middle node may identify timing parameter, symbolid, timeoffset, cplength, framestructure (SCS), numsymbol, etc. included in a C-plane message to determine symbol reference timing. A method by which the middle node determines symbol reference timing based on information included in a C-plane will be described in detail later in FIG. 12B.

In operation S1203, the middle node may generate a combination trigger to perform combination of uplink data based on the determined symbol reference timing. The middle node may determine combination trigger timing (e.g., T-waiting) based on a latest time (e.g., Ta3-prime-max) at which data combined with the middle node received from an upper node (e.g., controller or O-DU) at the determined symbol reference timing determined in operation S1202 is transmitted to the upper node, and a maximum time (e.g., T-combine) required for the middle node to combine data.

In operation S1204, the middle node may page a U-plane packet (or IQ payload) received and stored from a lower node (e.g., O-RU or another middle node) according to the determined combination trigger timing. The middle node may page the U-plane packet at combining timing based on main timing parameters, symbolid, eAxC_ID, and MAC address. The middle node may combine paged uplink U-plane packets (or IQ payload) and transmit them to an upper node. According to another embodiment, in cases (e.g., when messages with the same symbolid and eAxC_ID but different types are included, etc.) where accurate data cannot be paged based on symbolid, eAxC_ID, and MAC address, the middle node may check additional information to page accurate data. Multiple channels in a UL direction may be indicated with one eAxC_ID. There are a PuxCH corresponding to one SCS indicated by Section Type 1, and PUxCH, PRACH, NPRACH, NPUSCH, and RIM-RS of another SCS indicated by Section Type 3, and because reference timings of a user plane are different, they need to be distinguished from each other. When Section type 1 PUxCH and Section Type 3 PRACH use one eAxC_ID, user plane messages that follow them may be distinguished by a fiterIndex.

Section type 3 PRACH, NPRACH, and NPUSCH also coexist using one eAxC_ID, and user plane messages that follow them may be distinguished by the fiterIndex value. A method of classifying message types based on filterIndex will be described in detail later in FIGS. 12B and 12C. However, when two or more of PRACH, which is indicated by a filterIndex value of ‘0’ that shares one eAxC_ID, PUxCH, and RIM-RS, which use section type 1 and section type 3, etc., are used together, timing parameters and filterIndex alone are ambiguous and cannot be distinguished, but can be distinguished by referring to sectionId. In a control plane message, user plane reference timing and corresponding sectionId are additionally referred to in symbolid to identify a user plane message and page a packet. In this case, filterIndex may also be used in combination.

Like eMTC PRACH, messages with the same symbolid but different reference timings from among stored messages may be paged by identifying a user plane message by adding subframeId of a control plane message.

For example, like SCSs 30, 60, 120, and 240 kHz, messages with the same symbolid but different reference timings according to SlotId from among stored messages may be paged by identifying a user plane message by adding SlotId of a control plane message.

FIG. 12B may illustrate a method in which the middle node determines the U-plane symbol reference timing by parsing the received section type 3 UL C-plane message in operation S1202 of FIG. 12A. FIG. 12B may illustrate a method of determining symbol reference timing of PRACH related to section type 3.

A PRACH message in FIG. 12B may be the same or similar to the PRACH format C2 9015 described in FIG. 9A. As explained in FIG. 9A, when identical timing is applied to the PRACH message instead of following normal symbol reference timing, an error may occur. Therefore, FIG. 12A may show an example in which a middle node checks timing to calculate page timing for combining PRACH messages.

1205 in FIG. 12B shows symbol timing in a time domain for a PRACH format C2 message. A subframe boundary or slot boundary may be set at t0. PRACH format C2 1205 may be set to two divided messages 1200a and 1200b.

First, to determine symbol timing for the first message 1200a, the middle node may check a first C-plane message 1250. The first C-plane message 1250 may include filterIndex 1220a, timing parameter 1225a, startsymbolid 1230a, timeoffset 1210a, cplength 1215a, SCS 1235a, numsymbol 1240a, and sectionid 1245a fields.

The filterIndex 1220a may indicate information about whether a corresponding message is PRACH, a preamble format used, and a minimum filter pass bandwidth depending on its value. This will be explained later in FIG. 12C.

The timing parameter 1225a may indicate a certain timing parameter according to a message.

The startsymbolid 1230a may indicate an identifier of a symbol that starts first in a corresponding message structure.

The timeoffset 1210a may indicate a time offset from a slot boundary or subframe boundary (when an SCS is less than 15 kHz) to a CP (cyclic prefix) where the corresponding message structure starts.

The cplength 1215a may indicate a CP length of a repeated scheduling symbol in the corresponding message structure.

The SCS 1235a may indicate how many SCS the message has.

The numsymbol 1240a may indicate the total number of symbols included in the corresponding message structure.

The sectionid 1245a may be used to map a U-plane data section to a C-plane message related to corresponding data.

The middle node may identify the type of upload message through the received C-plane message, and may determine symbol timing to determine combining timing according to the identified type.

For example, referring to FIG. 12B, for the first message 1200a, the middle node may receive the first C-plane message 1250 and check the filterIndex 1220a in the received first C-plane message. In the case of the first message 1200a, the filterIndex 1220a is 3, so the message may be identified as PRACH. For a PRACH message, when typical symbol timing is applied, it may not match actual timing and an error in symbol duration may occur. Therefore, symbol timings 1202a, 1202b, 1202c, and 1202d corresponding to the PRACH message need to be determined. To determine the symbol timings 1202a, 1202b, 1202c, and 1202d of the PRACH message, the timeoffset 1210a, the cplength 1215a, and the SCS 1235a may be checked and determined while a subframe boundary or slot boundary 1201 is known. First, based on the fact that a value of the startsymbolid 1230a is 2, it can be identified that the first symbol after CP is symbol #2. To determine the first symbol timing (t1) 1202a, the middle node may add D, which is a value of the timeoffset 1210a, and E, which is a value of the cplength 1215a indicating a length of the CP, to the subframe boundary or slot boundary 1201. For example, in PRACH FORMAT C2, cplength may be 0. For PRACH FORMAT 0, cplength and timeoffset may be set to interchangeable values. That is, the first symbol timing (t1) 1202a may be determined as t0+D+E. The second symbol timing (t2) 1202b is a value obtained by adding a symbol size to the first symbol timing 1202a, and the symbol size may be determined as 1/SCS. Because an SCS confirmed in the first C-plane message 1250 is F, the second symbol timing (t2) 1202b may be determined as t0+D+E+1/F. The third symbol timing (t3) 1202c and the fourth symbol timing (t4) 1202d may also be calculated in a similar manner. Because it is confirmed that the numsymbol 1240a is 4 in the first C-plane message 1250, the middle node may determine symbol timings by calculating only up to the fourth symbol timing (t4) 1202d. Once the symbol timings are determined, the middle node may perform combining by paging a U-plane packet stored at corresponding timing. The U-plane message may include the filterIndex 1220a, timing parameter 1225a, numsymbol 1240a, and sectionid 1245a. For example, a first U-plane message 1251a, a second U-plane message 1251b, a third U-plane message 1251c, and a fourth U-plane message 1251d may include the filterIndex 1220a, timing parameter 1225a, and sectionid 1245a, respectively, and may include different symbolids.

In a case of the second message 1200b, symbol timing may be determined in the same manner. At this time, timeoffset 1210b and the startsymbolid 1230b of each of the first message 1200a and the second message 1200b are set differently, and when they are included in the same message, the remaining parameters may be set the same. In a case of the second message 1200b, a method of calculating symbol timings 1203a, 1203b, 1203c, and 1203d is the same as that of the first message 1200a, with the only difference being that the timeoffset 1210b is L and the sartsymbolid 1230b is 8.

Referring to FIG. 12C, filterIndex may have a total of 9 values. First, when the filterIndex value is 0 (1290), it is used for a general channel filter and basic timing may be applied. When the filterIndex values are 1, 2, 3, 5, 6, and 7 (1292 and 1296), they may indicate that an uplink is PRACH, and when the filterIndex values is 4 (1294), it may indicate that an uplink is NPRACH. When the filterIndex value is 1, it may be used in LTE and NR, when the filterIndex value is 2 or 3, it may be used in NR, when the filterIndex value is 4, it may be used in LTE NB-IOT, and when the filterIndex value is 5, it may be used only in LTE. When the filterIndex value is 8 (1298), it may be used in NPUSCH.

Therefore, the middle node may determine whether a corresponding message is PRACH by checking the filterIndex. When the message is PRACH, the middle node does not apply basic symbol timing and may calculate symbol timing appropriate for the message through information included in a C-plane. When combining data, the middle node may select and page data corresponding to PRACH.

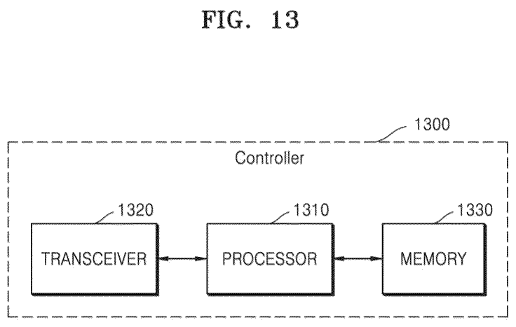

FIG. 13 is a view of a configuration of a controller according to an embodiment.

The controller in FIG. 12 is the same as the controllers or O-DUs described in FIGS. 1A to 12C and may be configured to perform the same or similar operations.

According to an embodiment, in a controller 1300, functions may be included in one device, or each function may be divided into each device.

The controller 1300 according to an embodiment may include a controller (or processor) 1310 that controls operations of the controller, a transceiver (or transmitter/receiver) 1320 including a transmitter and a receiver, and a memory 1330. However, the disclosure is not limited to the above example, and the controller 1300 may include more or fewer components than those shown in FIG. 13.

According to an embodiment, the transceiver 1320 may transmit and receive signals to and from other network nodes (e.g., southbound node, northbound node, O-RU, O-DU, middle node, or upper network entity). Signals transmitted and received from the controller may include C-plane, U-plane, S-plane and M-plane signals, uplink data, and downlink data. In addition, the transceiver 1320 may receive a signal through a wireless path or a wired path such as a fiber and transmit it to the processor 1310, and transmit a signal determined and output from the processor 1310 through a channel.

According to an embodiment, the processor 1310 may control the controller to perform the operation of any one of the embodiments of FIGS. 1As to 12C. The processor 1310, memory 1330, and transceiver 1320 do not necessarily have to be implemented as separate modules, and may be implemented as one component in the form of a single chip. The processor 1310, memory 1330, and transceiver 1320 may be electrically connected to each other. In addition, the processor 1310 may be an AP, a CP, a circuit, an application-specific circuit, or at least one processor.

According to an embodiment, the memory 1330 may store data such as basic programs, applications, and configuration information for the operation of the controller 1300. In addition, the memory 1130 may store uplink and downlink data received by the controller. In particular, the memory 1330 may provide stored data according to a request from the processor 1310. The memory 1330 may be composed of a storage medium such as ROM, RAM, hard disk, CD-ROM, and DVD, or a combination of storage media. In addition, there may be a plurality of memories 1330. In addition, the processor 1310 may perform the embodiments described above based on a program for performing the embodiments described above stored in the memory 1330.

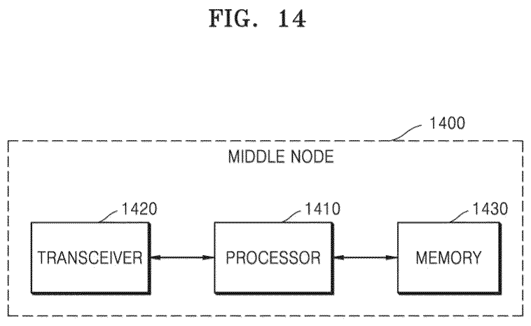

FIG. 14 is a view of a configuration of a middle node according to an embodiment.

The middle node in FIG. 14 is the same as the middle node (FHM, cascade FHM, or cascade O-RU) described in FIGS. 1A to 12A and may be configured to perform the same or similar operations.

According to an embodiment, a middle node 1400 may include the middle node (FHM or Cascade O-RU) described in FIGS. 1A to 12C. In the middle node, functions may be included in one device, or each function may be divided into each device.

The middle node 1400 according to an embodiment may include a controller (or processor) 1410 that controls operations of the middle node, a transceiver (or transmitter/receiver) 1420 including a transmitter and a receiver, and a memory 1430. However, the disclosure is not limited to the above example, and the middle node 1400 may include more or fewer components than those shown in FIG. 14.

According to an embodiment, the transceiver 1420 may transmit and receive signals to and from other network nodes (e.g., southbound node, northbound node, O-DU, O-RU, controller, or other middle nodes). Signals transmitted and received from the middle node may include C-plane, U-plane, S-plane and M-plane signals, uplink data, and downlink data. In addition, the transceiver 1420 may receive a signal through a path such as a fiber and transmit it to the processor 1410, and transmit a signal determined and output from the processor 1410 through the channel.

According to an embodiment, the processor 1410 may control a middle node device to perform the operation of any one of the embodiments of FIGS. 1A to 12C. The processor 1410, memory 1430, and transceiver 1420 do not necessarily have to be implemented as separate modules, and may be implemented as one component in the form of a single chip. The processor 1410, memory 1430, and transceiver 1420 may be electrically connected to each other. In addition, the processor 1410 may be an application processor (AP), a communication processor (CP), a circuit, an application-specific circuit, or at least one processor. The processor 1410 of the middle node 1400 may include a combiner, a copier, a pager, a trigger generator, and a parser to perform operations. Each function may be included in a separate device or may be included together in the processor 1410. The processor may be controlled to perform operations of a combiner, copier, pager, trigger generator, and parser. The parser may analyze received C/U, M, and S-plain messages and identify information contained in the messages. The trigger generator may calculate symbol timing or generate combining timing or a combination trigger based on the identified information. The pager may page uplink data stored in the memory corresponding to the generated trigger. The combiner may combine the paged data.

According to an embodiment, the memory 1430 may store data such as basic programs, applications, and configuration information for the operation of the middle node. In addition, the memory 1430 may store uplink and downlink data received by the middle node. In particular, the memory 1430 may provide stored data according to a page from the processor 1410. The memory 1430 may be composed of a storage medium such as ROM, RAM, hard disk, CD-ROM, and DVD, or a combination of storage media. The memory 1430 may include at least one buffer for temporarily storing uplink data or downlink data. In addition, there may be a plurality of memories 1430. In addition, the processor 1410 may perform the embodiments described above based on a program for performing the embodiments described above stored in the memory 1430.

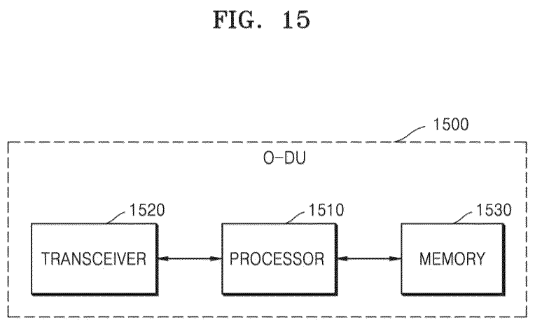

FIG. 15 is a view of a configuration of an O-DU according to an embodiment.

The O-DU in FIG. 15 is the same as the O-DUs described in FIGS. 1A to 12C and may be configured to perform the same or similar operations.

According to an embodiment, in an O-DU 1500, functions may be included in one device, or each function may be divided into each device.

The O-DU 1500 according to an embodiment may include a controller (or processor) 1510 that controls operations of the O-DU, a transceiver (or transmitter/receiver) 1520 including a transmitter and a receiver, and a memory 1530. However, the disclosure is not limited to the above example, and the O-DU 1500 may include more or fewer components than those shown in FIG. 15.

According to an embodiment, the transceiver 1520 may transmit and receive signals to and from other network nodes (e.g., southbound node, northbound node, O-RU, controller, middle node, or upper network entity). Signals transmitted and received from the middle node may include C-plane, U-plane, S-plane and M-plane signals, uplink data, and downlink data. In addition, the transceiver 1520 may receive a signal through a wireless path or a wired path such as a fiber and transmit it to the processor 1510, and transmit a signal determined and output from the processor 1510 through the channel.

According to an embodiment, the processor 1510 may control the O-DU to perform the operation of any one of the embodiments of FIGS. 1A to 12C. The processor 1510, memory 1530, and transceiver 1520 do not necessarily have to be implemented as separate modules, and may be implemented as one component in the form of a single chip. The processor 1510, memory 1530, and transceiver 1520 may be electrically connected to each other. In addition, the processor 1510 may be an AP, a CP, a circuit, an application-specific circuit, or at least one processor.

According to an embodiment, the memory 1530 may store data such as basic programs, applications, and configuration information for the operation of the O-DU 1500. In addition, the memory 1530 may store uplink and downlink data received by the O-DU. In particular, the memory 1530 may provide stored data according to a request from the processor 1510. The memory 1530 may be composed of a storage medium such as ROM, RAM, hard disk, CD-ROM, and DVD, or a combination of storage media. In addition, there may be a plurality of memories 1530. In addition, the processor 1510 may perform the embodiments described above based on a program for performing the embodiments described above stored in the memory 1530.

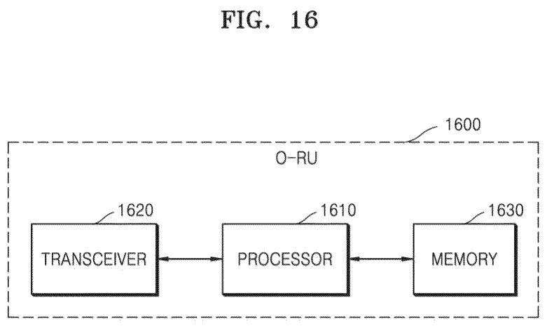

FIG. 16 is a view of a configuration of an O-RU according to an embodiment.

The O-RU in FIG. 16 is the same as the O-RUs described in FIGS. 1A to 12C and may be configured to perform the same or similar operations.

According to an embodiment, in an O-RU 1600, functions may be included in one device, or each function may be divided into each device.

The O-RU 1600 according to an embodiment may include a controller (or processor) 1610 that controls operations of the O-RU, a transceiver (or transmitter/receiver) 1620 including a transmitter and a receiver, and a memory 1630.

However, the disclosure is not limited to the above example, and the O-RU 1600 may include more or fewer components than those shown in FIG. 12.

According to an embodiment, the transceiver 1620 may transmit and receive signals to and from other network nodes (e.g., southbound node, northbound node, O-DU, middle node, or upper network entity). Signals transmitted and received from the controller may include C-plane, U-plane, S-plane and M-plane signals, uplink data, and downlink data. In addition, the transceiver 1620 may receive a signal through a wireless path or a wired path such as a fiber and transmit it to the processor 1610, and transmit a signal determined and output from the processor 1610 through the channel.

According to an embodiment, the processor 1610 may control the O-RU to perform the operation of any one of the embodiments of FIGS. 1A to 12C. The processor 1610, memory 1630, and transceiver 1620 do not necessarily have to be implemented as separate modules, and may be implemented as one component in the form of a single chip. The processor 1610, memory 1630, and transceiver 1620 may be electrically connected to each other. In addition, the processor 1610 may be an AP, a CP, a circuit, an application-specific circuit, or at least one processor.

According to an embodiment, the memory 1630 may store data such as basic programs, applications, and configuration information for the operation of the O-RU 1600. In addition, the memory 1630 may store uplink and downlink data received by the O-RU. In particular, the memory 1630 may provide stored data according to a request from the processor 1610. The memory 1630 may be composed of a storage medium such as ROM, RAM, hard disk, CD-ROM, and DVD, or a combination of storage media. In addition, there may be a plurality of memories 1630. In addition, the processor 1610 may perform the embodiments described above based on a program for performing the embodiments described above stored in the memory 1630.

Various operations of the methods described above may be performed by any suitable device capable of performing corresponding functions. The device includes, but is not limited to, various hardware and/or software components and/or modules such as an ASIC or a processor. In general, when there are operations corresponding to the drawings, these operations may have a corresponding counterpart and functional components having the same number as the number of the counterpart.

The various illustrative logic blocks, modules, and circuits described in connection with the disclosure may be implemented or performed by a general-purpose processor designed to perform the functions disclosed herein, a digital signal processor (DSP), ASIC, FPGA or other programmable logic device (PLD), a discrete gate or transistor logic device, discrete hardware components, or any combination thereof. The general-purpose processor may be a microprocessor, but may alternatively be any commercially available processor, controller, microcontroller, or state machine. The processor may also be implemented in a combination of computing devices, for example, a combination of the DSP and the microprocessor, a plurality of microprocessors, one or more microprocessors in connection with a DSP core, or any other configuration.

In addition, the term “determining” encompasses a wide variety of actions. For example, the term “determining” may include computing, processing, deriving, examining, looking up (e.g., looking up in a table, database, or other data structure), identifying, and the like. The term “determining” may also include receiving (e.g., receiving information), accessing (accessing data in a memory), and the like. The term “determining” may also include resolving, selecting, choosing, establishing, and the like.

Numerous modifications and adaptations will be readily apparent to one of ordinary skill in the art without departing from the spirit and scope of the disclosure.

In this regard, the present embodiments may have different forms and should not be construed as being limited to the descriptions set forth herein.

While the disclosure has been particularly shown and described with reference to embodiments thereof, it will be understood that various changes in form and details may be made therein without departing from the spirit and scope of the following claims.

What is claimed is:

1. A method performed by a middle node in a communication system, the method comprising:
identifying a section type 3 control plane message indicating an uplink packet;
determining user plane symbol reference timing based on the section type 3 control plane message;
determining combining timing based on the determined user plane symbol reference timing; and
paging and combining a stored uplink packet based on the determined combining timing.

2. The method of claim 1, wherein the determining of user plane symbol reference timing based on the section type 3 control plane message comprises:
identifying at least one of timing parameter, symbolid, timeoffset, cplength, framestructure (subcarrier spacing (SCS)), and numsymbol information included in the control plane message; and
determining user plane symbol reference timing based on the identified information and a subframe boundary or slot boundary.

3. The method of claim 1, wherein the paging and combining of a stored uplink packet based on the determined combining timing comprises:
paging data corresponding to the determined combining timing based on symbolid, extended antenna carrier (eAxC)_ID, and transport flow; and, when there are pieces of data with the same symbolid, eAxC_ID, and transport flow and different user plane symbol reference timings, paging data corresponding to the determined combining timing based on filterIndex, sectionId, subframeId, or slotId included in the uplink packet,
wherein the transport flow is determined by a combination of a destination and source of a medium access control (MAC) address or an Internet protocol (IP) address.

4. The method of claim 3, wherein the paging of data corresponding to the determined combining timing based on the filterIndex included in the uplink packet comprises:
identifying, when a value of the filterIndex is 1 to 7, that a corresponding message is a physical random access channel (PRACH) message and paging data; and
identifying, when a value of the filterIndex is 8, that a corresponding message is a narrowband physical uplink shared channel (NPUSCH) message and paging data.

5. The method of claim 3, wherein the paging of data corresponding to the determined combining timing based on the sectionId included in the uplink packet comprises:
referring to sectionId in a control plane message indicating the uplink packet, identifying a user plane message including the sectionId and paging data.

6. A middle node in a communication system, the middle node comprising:
a transceiver;
a memory; and
at least one processor electrically connected to the transceiver and the memory,
wherein the at least one processor is configured to:
identify a section type 3 control plane message indicating an uplink packet;
determine user plane symbol reference timing based on the section type 3 control plane message;
determine combining timing based on the determined user plane symbol reference timing; and
page and combine a stored uplink packet based on the determined combining timing.

7. The middle node of claim 6, wherein the at least one processor is configured to:
identify at least one of timing parameter, symbolid, timeoffset, cplength, framestructure (subcarrier spacing (SCS)), and numsymbol information included in the control plane message; and
determine user plane symbol reference timing based on the identified information and a subframe boundary or slot boundary.

8. The middle node of claim 6, wherein the at least one processor is configured to:
page data corresponding to the determined combining timing based on symbolid, extended antenna carrier (eAxC)_ID, and transport flow; and,
when there are pieces of data with the same symbolid, eAxC_ID, and transport flow and different user plane symbol reference timings, page data corresponding to the determined combining timing based on filterIndex, sectionId, subframeId, or slotId included in the uplink packet,
wherein the transport flow is determined by a combination of a destination and source of a medium access control (MAC) address or an Internet protocol (IP) address.

9. The middle node of claim 8, wherein the at least one processor is configured to:
identify, when a value of the filterIndex is 1 to 7, that a corresponding message is a physical random access channel (PRACH) message and page data; and
identify, when a value of the filterIndex is 8, that a corresponding message is a narrowband physical uplink shared channel (NPUSCH) message and page data.

10. The middle node of claim 8, wherein the at least one processor is configured to:
referring to sectionId in a control plane message indicating the uplink packet, identify a user plane message including the sectionId and page data.
